(19) United States
(12) Patent Application Publication
(10) Pub. No.: US 2006/0066046 A1
(43) Pub. Date: Mar. 30, 2006

(54) Apparatus and system for supplying game articles

(75) Inventors: Kazuo Okada, Tokyo (JP); Nobukatsu Hiranoya, Tokyo (JP); Kentaro Hayashi, Tokyo (JP); Takashi Abe, Tokyo (JP); Akira Shimizu, Tokyo (JP)

Correspondence Address: SNIDER & ASSOCIATES, P. O. BOX 27613, WASHINGTON, DC, 20038-7613, US

(73) Assignee: Aruze Corporation, Tokyo (JP)

(21) Appl. No.: 11/236,634

(22) Filed: Sep. 28, 2005

(30) Foreign Application Priority Data
Sep. 30, 2004 (JP) 2004-288188
Sep. 30, 2004 (JP) 2004-288194

(51) Int. Cl. G07C 15/00; A63F 7/04; A63F 9/00

(52) U.S. Cl. 273/144 R

(57) ABSTRACT

Game article supply apparatus and game system capable of sustaining players' will to collect game articles are offered. The supply system has an accommodation unit equipped with accommodation portions for accommodating plural game articles used in games. The system further includes a delivery unit for delivering the game articles accommodated in the accommodation unit. Plural kinds of game articles are accommodated in the accommodation portions. The system has a game article supply portion which supplies a game article delivered from the accommodation unit by the delivery unit, based on information about a game article

### CROSS REFERENCE TO RELATED APPLICATIONS

The present application is based on and claims priority of Japanese patent applications No.2004-288188 and No.2004-288194 both filed on Sep. 30, 2004, the entire contents of which are hereby incorporated by reference.

### FIELD OF THE INVENTION

The present invention relates to apparatus and system for supplying game articles such as figures, cards, and cassettes to game players.

### BACKGROUND OF THE INVENTION

Game machines permitting games to be played using game articles such as figures, cards, and cassettes have been heretofore known. For example, Patent Reference 1 discloses a card game apparatus having a reading means for reading data from plural cards placed on a play field and a means for displaying images corresponding to the read data. Images corresponding to the combinations of plural cards arrayed by human players are displayed, whereby team tactics can be simulated.

Furthermore, game article supply apparatus for supplying game articles to human players is known. For example, Patent Reference 2 discloses a game system mounted together with a game machine equipped with display units. The game system has a capsule vender (game article supply apparatus) in which figures (game articles) contained in capsules are held. When a given delivery operation is performed, capsules are delivered from the vender.

[Patent Reference 1] JP-A-2002-301264

[Patent Reference 2] JP-A-2002-153675

According to the game system described in the above-cited Patent Reference 2, game articles simulate characters appearing in games. Therefore, the articles can be subjects of collections for human players. In this case, a player who tries to collect plural figures, he or she will repeat the delivery operation on the game article supply apparatus.

However, if the delivery operation is repeated, a newly supplied figure may be identical in group and kind with any one of the figures already possessed by the player, resulting in figure duplication. This will dwindle the player's will to collect game articles.

To prevent this, a method consisting of supplying plural kinds of game articles belonging to plural groups from one accommodation unit may be conceivable. In this case, players can know neither the group nor the kind of each game article to be supplied until the article is supplied to each player in practice. There is the danger that a game article belonging to a group utterly different from the group of game particles already possessed by the player is supplied. Accordingly, a game article that the player does not want may be supplied. Consequently, the player's will to collect articles may dwindle.

On the other hand, there is a possibility that a player gets tired of possessed figures and does not desire further use. Since such figures are not useful for the player, many of them tend to be discarded.

In view of this problem, even if a box is placed beside the game machine to recover figures, it is difficult to anticipate player's positive recovery provided that the adopted means is only to permit recovery of figures. Accordingly, the prior art game article supply apparatus cannot fully sustain players' will to collect game articles.

### SUMMARY OF THE INVENTION

Accordingly, the present invention has been made to solve the foregoing problem. It is an object of the invention to provide game article supply apparatus and system capable of sustaining players' will to collect game particles.

To solve the foregoing problem, a game article supply apparatus according to a first aspect of the present invention comprises: an accommodation unit having at least one accommodation portion for accommodating plural game articles used for games, the accommodation unit being designed such that plural kinds of game articles are accommodated in the accommodation unit; a delivery unit for delivering the game articles accommodated in the accommodation unit; and a game article supply portion which supplies a game article delivered from the accommodation unit by the delivery unit, based on information about a game article.

A game article supply apparatus according to a second aspect of the present invention is based on the game article supply apparatus according to the first aspect and further characterized in that the accommodation unit has plural accommodation portions, and that the game article supply portion has (a) a reading portion for reading identification information which is stored in storage * portions of the game articles, permits the game articles to be discriminated, and permits the accommodation portions to be identified, (b) an identification portion for identifying the accommodation portion corresponding to the identification information read by the reading portion, and (c) a delivery control portion for operating the delivery unit to deliver the game articles accommodated in the accommodation portion identified by the identification portion.

A game article supply apparatus according to a third aspect of the present invention is based on the game article supply apparatus according to the first aspect and further characterized in that the accommodation unit has plural accommodation portions and that the game article supply portion has (a) a reading portion for reading identification information which is accommodated in accommodation portions of the game articles, permits the game articles to be discriminated, and permits the accommodation portions to be identified, (b) an identification portion for identifying the accommodation portion corresponding to the identification information read by the reading portion, (c) a delivery control portion for operating the delivery unit to deliver the game articles accommodated in the accommodation portion identified by the identification portion, and (d) a setting portion for setting instruction information indicating whether or not the identification information has been read by the reading portion. The identification portion identifies the accommodation portion by lottery out of random numbers if the instruction information set by the setting portion indicates that the identification information has not been read.

A game article supply apparatus according to a fourth aspect of the present invention is based on the game article supply apparatus according to the first aspect and further characterized in that the game article supply portion has (a) an acceptance portion for performing an operation for accepting game articles from the outside, (b) a reading portion for reading identification information which is stored in storage portions of the game articles, permits the game articles to be discriminated, and permits the accommodation portions to be identified, (c) an acceptance control portion for operating the acceptance portion such that game articles to be recovered from which the identification information has been read can be accepted when the identification information is read by the reading portion, and (d) a delivery control portion for operating the delivery unit such that the game articles accommodated in the accommodation units are delivered when the game articles to be recovered are accepted by the acceptance portion.

A game article supply apparatus according to a fifth aspect of the present invention is based on the game article supply apparatus according to the first aspect and further characterized in that the accommodation unit has plural accommodation portions and that the game article supply portion has (a) an acceptance portion for performing an operation for accepting game articles from the outside, (b) a reading portion for reading identification information which is stored in storage portions of the game articles, permits the game articles to be discriminated, and permits the accommodation portions to be identified, (c) an acceptance control portion for operating the acceptance portion such that game articles to be recovered from which the identification information has been read can be accepted when the identification information is read by the reading portion, (d) a delivery control portion for operating the delivery unit such that the game articles accommodated in the accommodation units are delivered when the game articles to be recovered are accepted by the acceptance portion, (e) an identification portion for identifying the accommodation portion corresponding to the identification information read by the reading portion, and (f) a setting portion for setting an accommodation portion different from the accommodation portion identified by the identification portion as a target accommodation portion into which the accommodated game articles are delivered. The delivery control portion operates the delivery unit such that the accommodated game articles accommodated in the target accommodated portion set by the setting portion are delivered.

A game article supply system according to a sixth aspect of the present invention comprises: a game article supply apparatus having an accommodation unit and a delivery unit, the accommodation unit having an accommodation portion for accommodating plural game articles used for games, the delivery unit acting to deliver the game articles accommodated in the accommodation unit; and a game machine permitting image games to be played using images of games corresponding to the game articles. The accommodation portion accommodates plural kinds of game articles. The game article supply apparatus has a game article supply portion which supplies a game article delivered from the accommodation unit by the delivery unit, based on information about a game article.

A game article supply system according to a seventh aspect of the present invention is based on the game article supply system according to the sixth aspect and further characterized in that the accommodation unit has plural accommodation portions and that the game article supply portion has (a) a reading portion for reading identification information which is stored in storage portions of the game articles, permits the game articles to be discriminated, and permits the accommodation portions to be identified, (b) an identification portion for identifying the accommodation portion corresponding to the identification information read by the reading portion, and (c) a delivery control portion for operating the delivery unit to deliver the game articles accommodated in the accommodated portion identified by the identification portion.

A game article supply system according to an eighth aspect of the present invention is based on the game article supply system according to the sixth aspect and further characterized in that the game article supply portion has (a) an acceptance portion for performing an operation for accepting game articles from the outside, (b) a reading portion for reading identification information which is stored in storage portions of the game articles, permits the game articles to be discriminated, and permits the accommodation portions to be identified, (c) an acceptance control portion for operating the acceptance portion such that the game article to be recovered from which the identification information can be read can be accepted when the identification information is read by the reading portion, and (d) a delivery control portion for operating the delivery unit such that the game articles accommodated in the accommodated unit are delivered when the game articles to be recovered are accepted by the acceptance portion.

A game article supply system according to a ninth aspect of the present invention is based on the game article supply system according to the sixth aspect and further characterized in that the accommodation unit has plural accommodation portions and that the game article supply portion has: (a) an acceptance portion for performing an operation for accepting game articles from the outside, (b) a reading portion for reading identification information which is stored in storage portions of the game articles, permits the game articles to be discriminated, and permits the accommodation portions to be identified, (c) an acceptance control portion for operating the acceptance portion such that game articles to be recovered from which the identification information has been read can be accepted when the identification information is read by the reading portion, (d) a delivery control portion for operating the delivery unit such that the game articles accommodated in the accommodation units are delivered when the game articles to be recovered are accepted by the acceptance portion, (e) an identification portion for identifying the accommodation portion corresponding to the identification information read by the reading portion, and (f) a setting portion for setting an accommodation portion different from the accommodation portion identified by the identification portion as a target accommodation portion into which the already accommodated game article is delivered. The delivery control portion operates the delivery unit such that the game article already accommodated in the target accommodated portion set by the setting portion is delivered.

According to the present invention, game article supply apparatus and game article supply system capable of sustaining players' will to collect game articles can be offered.

### BRIEF DESCRIPTION OF THE DRAWINGS

FIG. 1 is a perspective view showing the whole configuration of a game article supply apparatus associated with a first embodiment of the present invention.

FIG. 2 is a partially cutaway perspective view of the game article supply apparatus.

FIG. 3 is a schematic side elevation of main portions of a game article supply apparatus.

FIG. 4 is a block diagram mainly showing the internal configuration.

FIG. 5 is a block diagram showing one example of the internal configuration of an image control circuit.

FIG. 6 is an exploded perspective view showing the configuration of a figure.

FIG. 7 is a flowchart illustrating a procedure for operations from start to end of processing in a game article supply apparatus.

FIG. 8 is a flowchart illustrating a procedure for operations of a pretreatment.

FIG. 9 is a flowchart illustrating a procedure for operations of processing to be performed in cases where there is a figure.

FIG. 10 is a flowchart illustrating a procedure for operations of processing to be performed in cases where there is no figure.

FIG. 11 is a diagram illustrating the contents of a table in which values of random numbers and group codes are stored in an interrelated manner.

FIG. 12 is a system diagram of a game article supply system equipped with a game article supply apparatus and plural game machines.

FIG. 13 is a perspective view showing a game article supply apparatus, plural game machines, and a card vending machine.

FIG. 14 is a block diagram, mainly showing the internal configuration of a game article supply apparatus associated with a game article supply system.

FIG. 15 is a perspective view showing the whole configuration of a game machine.

FIG. 16 is a block diagram showing the internal configuration of the game machine.

FIG. 17 is a flowchart illustrating a procedure for operations from start to end of processing in the game machine.

FIG. 18 is a flowchart illustrating the operation from start to end of processing in a game article supply apparatus.

FIG. 19 is a perspective view showing the whole configuration of a game article supply apparatus associated with a third embodiment of the invention.

FIG. 20 is a partially cutaway perspective view of the game article supply apparatus.

FIG. 21 is a side elevation schematically showing main portions of the game article supply apparatus.

FIG. 22 is a cross-sectional view taken on line XXII-XXII of a recovery unit in FIG. 1.

FIG. 23 is a block diagram of the game article supply apparatus, mainly showing the internal structure.

FIG. 24 is a block diagram showing one example of the internal structure of an image control circuit.

FIG. 25 is a flowchart illustrating a procedure for operations from start to end of processing in the game article supply apparatus.

FIG. 26 is a flowchart illustrating a procedure of operations of a pretreatment.

FIG. 27 is a flowchart illustrating a procedure for operations of processing for delivering a different figure.

FIG. 28 is a flowchart illustrating a procedure for operations of processing to be performed in cases where there is a figure.

FIG. 29 is a flowchart illustrating a procedure for operations of processing to be performed in cases where there is no figure.

FIG. 30 is a system diagram of a game article supply system equipped with a game article supply apparatus and plural game machines.

FIG. 31 is a perspective view showing a game article supply apparatus, plural game machines, and a card vending machine.

FIG. 32 is a block diagram showing the internal configuration of a game article supply apparatus.

FIG. 33 is a perspective view showing the whole configuration of a game machine.

FIG. 34 is a block diagram showing the internal configuration of the game machine.

FIG. 35 is a flowchart illustrating a procedure for operations for control of delivery and processing of a game from start to end of processing in the game machine.

FIG. 36 is a flowchart illustrating a procedure for operations of processing for recovering and delivering a figure.

### DESCRIPTION OF THE PREFERRED EMBODIMENTS

### First Embodiment

A game article supply apparatus associated with a first embodiment of the present invention is hereinafter described. Note that like components are indicated by like reference numerals and that repeated description is omitted.

(Whole Configuration of Game Article Supply Apparatus)

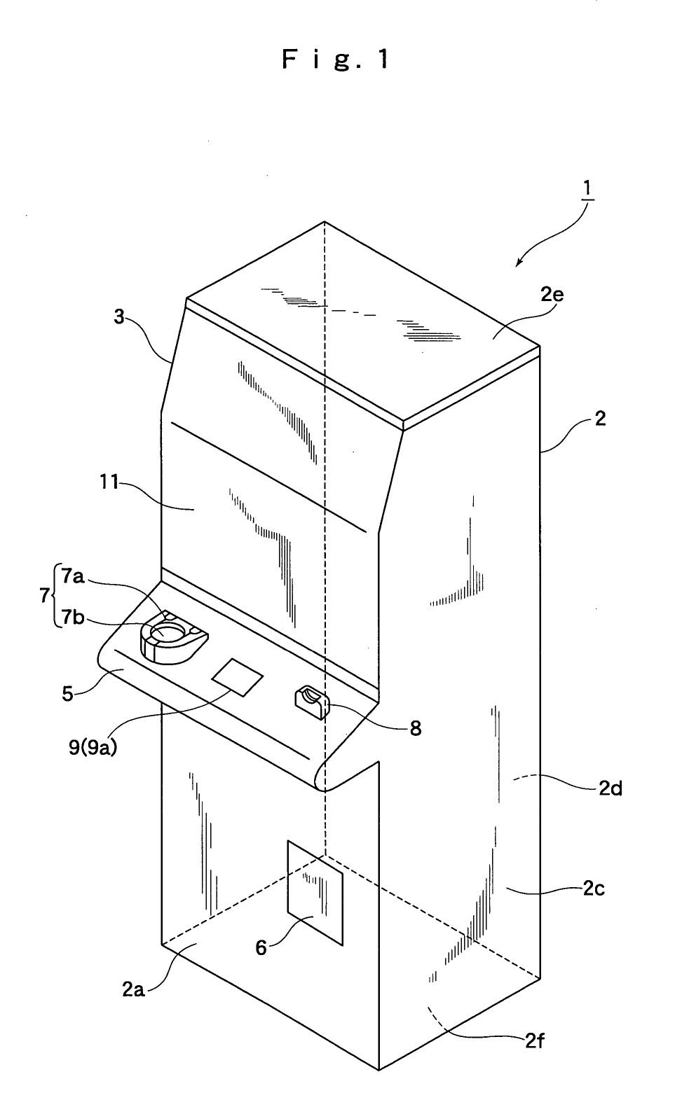

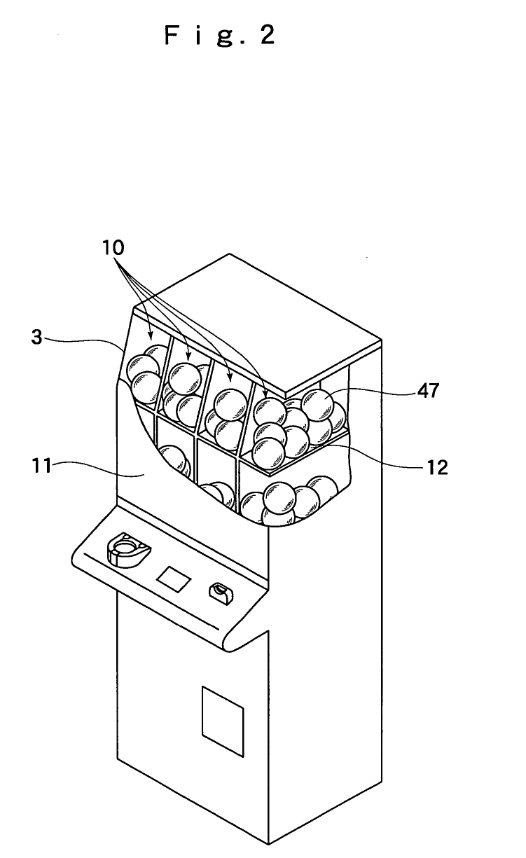

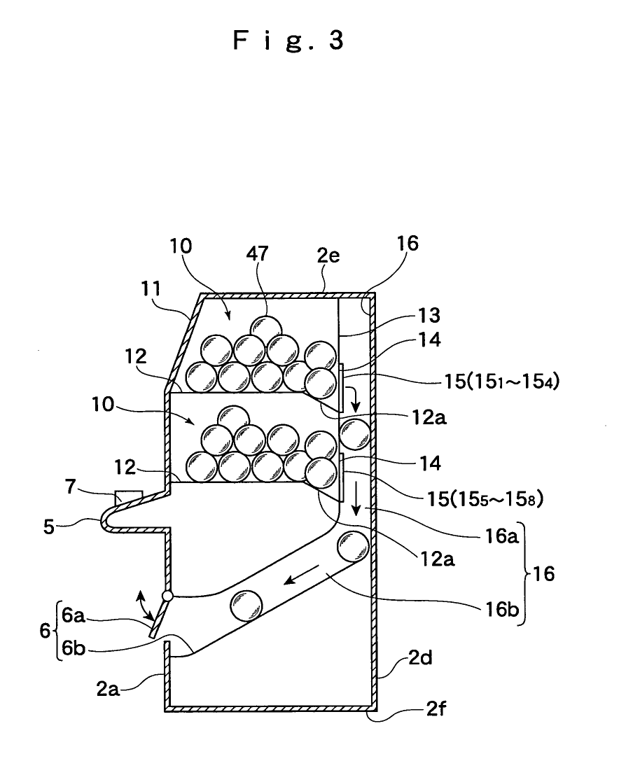

FIG. 1 is a perspective view showing the whole configuration of a game article supply apparatus 1 associated with the first embodiment of the present invention. FIG. 2 is a partially cutaway perspective view of the game article supply apparatus 1. FIG. 3 is a side elevation schematically showing main portions of the game article supply apparatus 1. This apparatus 1 for supplying a game article is designed to deliver a capsule 47 (described later) holding a FIG. 40 therein in response to insertion of a coin or coins such as medals for a game or token. Then, the apparatus can deliver the FIG. 40 contained in the capsule 47 to the player.

The apparatus 1 for supplying a game article has a housing 2, an accommodation unit 3, and a delivery unit 4. The accommodation unit 3 has plural accommodation portions 10 (eight accommodation portions in the present embodiment). Each accommodation portion 10 holds an appropriate number of capsules 47 containing FIGS. 40. The delivery unit 4 delivers the capsules 47 from each accommodation portion 10. With respect to the FIGS. 40 delivered from the game article supply apparatus 1, only one FIG. 40 is held in each capsule 47. The FIG. 40 is used in a manner described in detail later in a game machine 201 (described later) performing an image game in which a character is made to perform actions in response to player's manipulations.

The housing 2 has a front panel 2a constituting a front lower portion of the game article supply apparatus 1, a left side panel 2b, a right side panel 2c, a rear panel 2d, a top panel 2e, and a bottom panel 2f. In the housing 2, a transparent panel 11 (described later) is mounted between the top portion of the front panel 2a and top panel 2e. The housing 2 is a substantially rectangular parallelepiped. A control panel 5 protrudes forwardly from the interface between the front panel 2a and the transparent panel 11 and is located substantially at the midpoint in the vertical direction of the housing 2. The front panel 2a is provided with a capsule takeout port 6. In the housing 2, a discharge path 16 is secured between a rear plate 13 (described later) and the rear panel 2d.

As shown in FIG. 3, the capsule takeout port 6 has an open/close door 6a that can be pulled upward toward the front and opened and closed and a tray portion 6b for receiving the capsule 47 delivered from the accommodation portion 10. The capsule takeout portion 6 permits the player to take out the capsule 47 delivered to the tray portion 6b by pulling the open/close door 6a upwardly and forwardly from outside the housing 2.

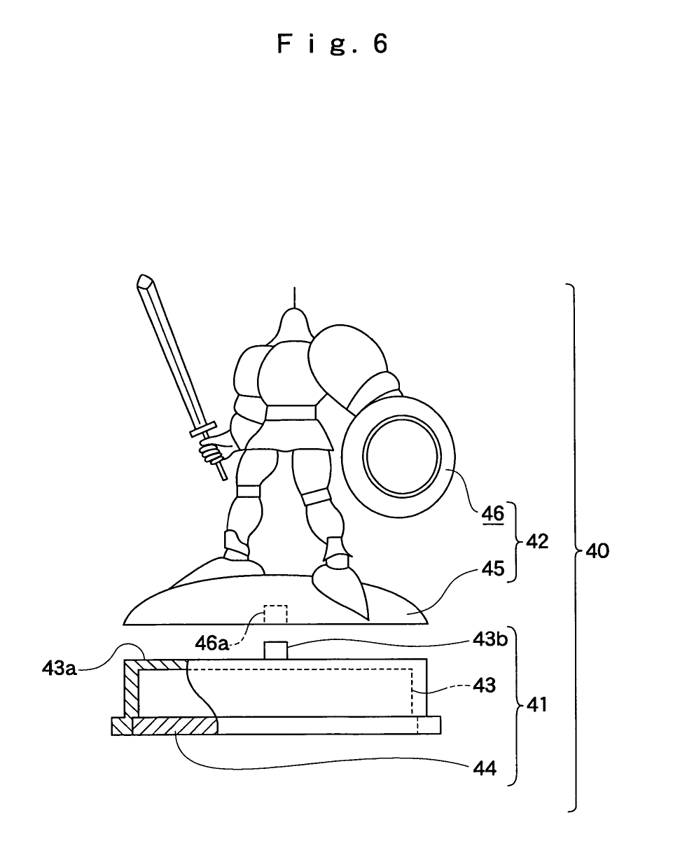

The control panel 5 has an authentication unit 7 (described later), a coin insertion port 8, and a display unit 9. The authentication unit 7 is the reading portion in the present invention and has a pedestal-mounting portion 7a fixedly mounted to the surface of the control panel 5 and a reading portion 7b. The pedestal-mounting portion 7a has an inner recess corresponding in shape to a thick-walled disk-like pedestal portion 41 of a FIG. 40 (see FIG. 6). The pedestal portion 41 can be fitly mounted into the recess. The reading portion 7b is positioned in the recess formed in the pedestal-mounting portion 7a, and has an IC chip reader (not shown). The IC chip reader reads a figure ID (identification information in the present invention) recorded on an IC chip 44 incorporated in the pedestal portion 41 of the mounted FIG. 40.

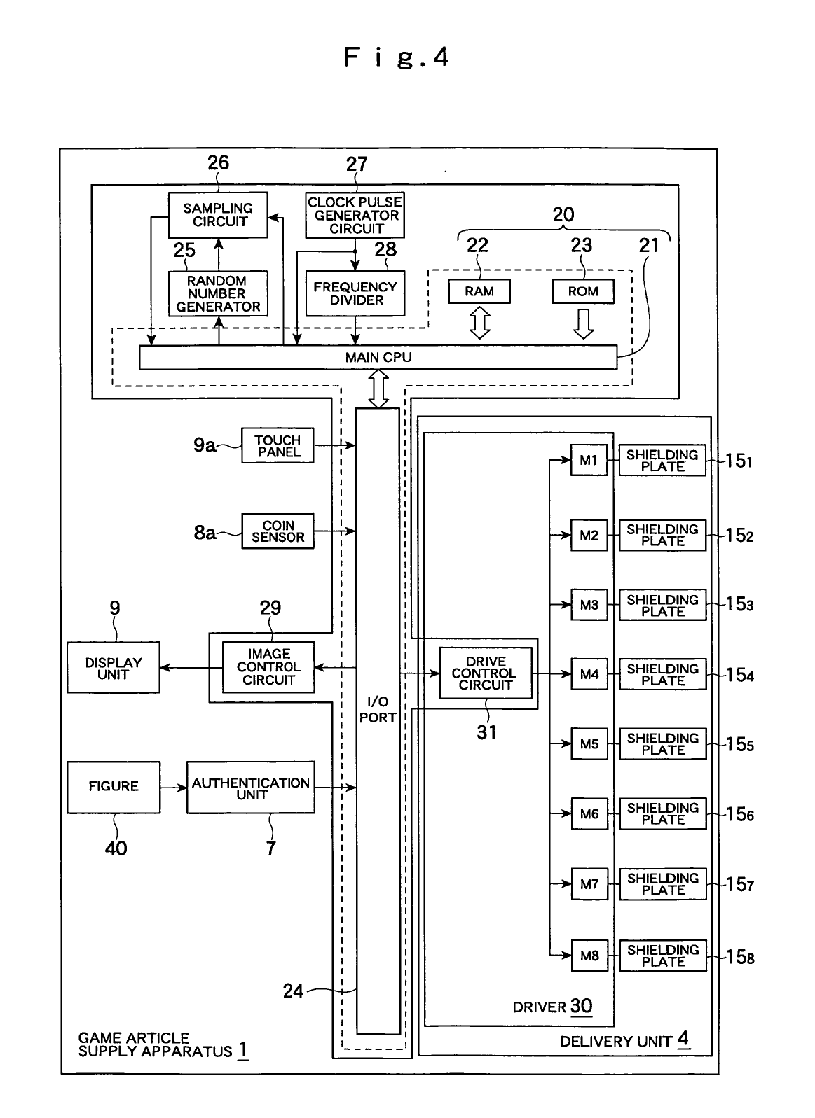

When the player wants supply of the figure, a coin necessary for the supply can be inserted into the coin insertion port 8. Furthermore, as shown in FIG. 4, a coin sensor 8a for detecting the inserted coin is connected to the coin insertion port 8. When such a detection is made, the sensor outputs a corresponding detection signal to a main CPU 21 (described later).

The display unit 9 has a liquid crystal display. A selection screen prompting the player to select whether there is a figure is displayed on the display unit. Furthermore, a touch panel 9a is mounted on the front side.

The touch panel 9a is mounted to provide a cover over the display screen of the display unit 9. The touch panel detects the position touched by the player's finger and enters a positional signal corresponding to the detected position into the main CPU 21. Using the touch panel 9a, the player performs a given manipulation such as choice between the presence and absence of a figure as described later. The touch panel 9a has a rectangular transparent plate, for example, on which a conductive substance has been applied. A voltage is applied from electrodes disposed at the four corners of the transparent plate. When the player's finger touches the plate, a feeble change in electrical current is caused. This is detected using the electrodes. The position touched by the player's finger is detected.

The accommodation unit 3 is roughly divided into two stages, or upper and lower stages, by a partition plate 12 as shown in FIGS. 2 and 3. The four separate accommodation portions 10 are arrayed in the left-and-right direction at each stage. Thus, there are eight accommodation portions 10 in total. The separate accommodation portions 10 are so sized and partitioned that each accommodation portion 10 can hold plural capsules 47. The front side of each accommodation portion 10 is made of a transparent material such as acrylic resin or glass. Each accommodation portion 10 is covered by the transparent panel 11 that can be opened and closed via a hinge (not shown). The capsules 47 accommodated inside can be visually checked from the front side. The partition plate 12 has a portion closer to the rear panel 2d, the portion forming a slope 12a going downward toward the rear side.

Each accommodation portion 10 can be replenished with the capsules 47 or the capsules can be replaced by new ones from the front side of the game article supply apparatus 1 after opening the transparent panel 11. The FIGS. 40 are classified into 8 groups. Figures belonging to one of the groups are accommodated in each accommodation portion 10. In the present embodiment, the FIGS. 40 represent 8 kinds of characters appearing in the game machine 201. The FIGS. 40 belonging to each group (figure group) are the same character but are wearing different costumes or carrying weapons or the like. That is, the FIGS. 40 belonging to the same group are accommodated in the same accommodation portion 10, while the FIGS. 40 belonging to a different group are accommodated in a different accommodation portion 10. Mark and name indicating the figure group of the accommodated FIGS. 40 are indicated on the partition plate 12 and on the rear plate 13. Personnel of the arcade can refer to the mark and name and replenish or replace corresponding FIGS. 40. In the present embodiment, each figure belongs to any one of 8 figure groups A-H. A relationship table indicating the corresponding relationship between group codes indicating the figure groups A-H, the accommodation portions 10, and shielding plates 15 (described later) is accommodated in a ROM 23.

The accommodation unit 3 has the rear plate 13 extending substantially upright on the rear side of each accommodation portion 10. The rear plate 13 limits movement of the capsules 47 in the rearward direction. The rear plate 13 has 8 delivery ports 14 corresponding to the accommodation portions 10. The delivery ports 14 are normally closed off by the shielding plates 15 (described later). When a capsule 47 is discharged, the corresponding shielding plate 15 is moved to open the delivery ports 14, thus connecting the corresponding delivery port with the discharge path 16. The discharge path 16 has a collection path portion 16a located between the rear plate 13 and the rear panel 2d and a common path portion 16b connecting the collection path portion 16a to the capsule takeout port 6. The discharge path 16 is located more rearwardly than the rear plate 13 within the housing 2.

The delivery unit 4 has the eight shielding plates 15 (15, to 158) and a driver 30 (see FIG. 4) for driving the shielding plates 15 which are mounted in a corresponding manner to the accommodation portions 10. Each shielding plate 15 has a size to be able to close off the corresponding delivery port 14. The shielding plates 15 can be individually slid along guide rails (not shown) by the driver 30 to open and close the delivery ports.

FIG. 4 is a block diagram of the game article supply apparatus 1, mainly showing the internal configuration. The supply apparatus 1 consists mainly of a microcomputer 20, together with other components.

The microcomputer 20 is the identification portion in the present invention and has the main CPU (central processing unit) 21, a RAM (random access memory) 22, and the ROM (read only memory) 23. The main CPU 21 operates according to a program stored in the ROM 23. Signals from various components mounted on the control panel 5 are entered into the main CPU via an I/O port 24. At the same time, the main CPU exchanges signals with other components. Thus, the main CPU controls the operation of the whole apparatus 1 for supplying a game article. Data and programs used when the main CPU 21 operates are stored in the RAM 22. A control program executed by the main CPU 21, the relationship table, and other permanent data are stored in the ROM 23.

The game article supply apparatus 1 has a random number generator 25, a sampling circuit 26, a clock pulse generator circuit 27, and a frequency divider 28. The random number generator 25 operates under instructions from the main CPU 21 and produces a certain range of random numbers. The sampling circuit 26 extracts an arbitrary random number from among the random numbers produced by the random number generator 25 under instructions from the main CPU 21 and feeds the extracted random number to the main CPU 21. The clock pulse generator circuit 27 produces reference clock pulses for operating the main CPU 21. The frequency divider 28 supplies a signal obtained by frequency-dividing the reference clock pulses by a given period into the main CPU 21.

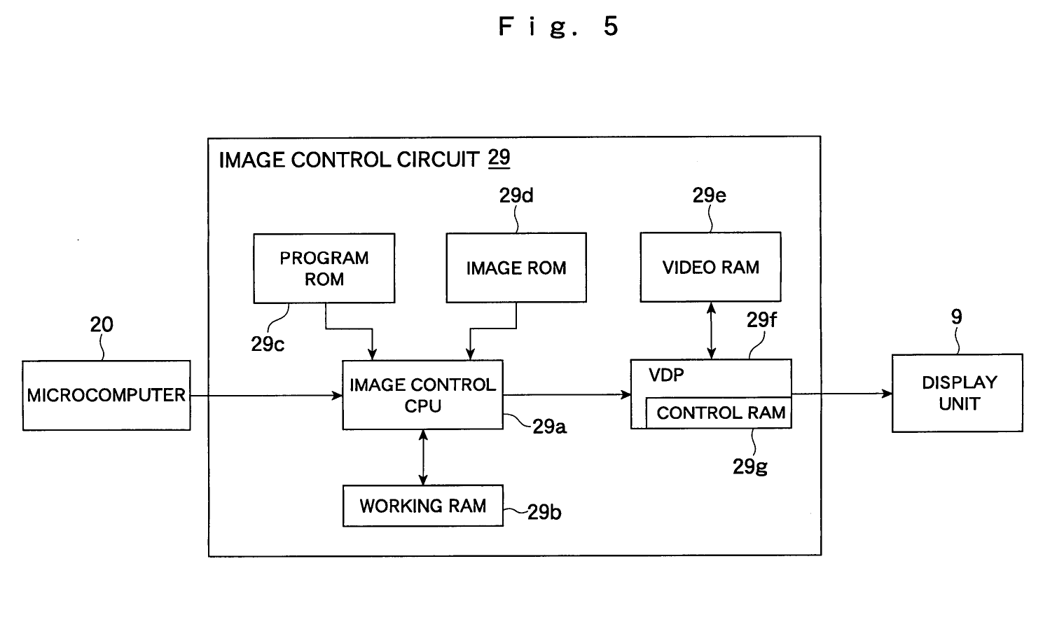

Furthermore, the game article supply apparatus 1 has an image control circuit 29 and the driver 30. The image control circuit 29 controls images displayed on the display unit 9 and displays various images for selecting whether there is a figure or not on the display unit 9. The image control circuit 29 has an image control CPU 29a, a working RAM 29b, a program ROM 29c, an image ROM 29d, a video RAM 29e, and a video display processor (VDP) 29f, as shown in FIG. 5. The image control CPU 29a determines an image displayed on the display unit 9 according to an image control program previously stored in the program ROM 29c based on parameters set by the microcomputer 20, the image control program being regarding display on the display unit 9. The working RAM 29b is configured to act as a temporary storage portion when the image control CPU 29a executes the image control program. The program ROM 29c stores image control programs and various selection tables. The image ROM 29d stores dot data for forming images. The video RAM 29e is formed as temporary storage portion when an image is created by the VDP 29f. The VDP 29f has the control RAM 29g, forms images corresponding to the contents of display provided on the display unit 9 determined by the image control CPU 29a, and outputs the formed images to the display unit 9.

The driver 30 has motors M1-M8 for producing powers to slide the shielding plates 15 (15₁-15₈) along the guide rails, drive mechanisms (not shown) for transmitting the powers from the motors M1-M8 to the shielding plates 15, and a drive control circuit 31. The motors M1-M8 are operated by drive signals output from the drive control circuit 31 and supply the powers to the drive mechanisms. The drive mechanisms transfer the powers supplied from the motors M1-M8 to the shielding plates 15₁-15₈ to slide them along the guide rails. The drive control circuit 31 outputs drive signals to the corresponding motors M1-M8 in accordance with a control signal output from the main CPU 21.

(Configuration of a Figure)

FIG. 6 is an exploded perspective view showing the configuration of the FIG. 40. This FIG. 40 is a game article in the present invention, and has the pedestal portion 41 and a figure body portion 42 representing a three-dimensional shape of each character appearing in a labyrinth combat game (described later) played using the game machine 201.

The pedestal portion 41 has a size corresponding to the l recess in the pedestal-mounting portion 7a, and is shaped as a hollow, thick-walled disk-like body. The pedestal portion 41 has a cylindrical pedestal body portion 43 and the IC chip 44. The body portion 43 has a top portion 43a and a bottom. The IC chip 44 is fitly mounted at the open end of the pedestal body portion 43. A protruding portion 43b is formed substantially in the center of the top portion 43a of the pedestal body portion 43. The IC chip 44 is a storage portion for storing identification information in the present invention. A figure ID intrinsic to the character corresponding to the figure body portion 42 is stored in the IC chip 44. The figure ID is unique to each individual FIG. 40 such that each figure can be discriminated. A group code indicating any one of figure groups A-H is contained in the figure ID. For example, the figure IDs of figures belonging to figure group A are “A001”, “A002”, “A003”, . . . . The code of the first one digit is a group code indicating a figure group, while the following three digits are codes for identifying the figure.

The figure body portion 42 has a foot portion 45 and a doll portion 46 simulating a character appearing in the labyrinth combat game. The foot portion 45 is provided with a recess 45a corresponding to the protruding portion 43b. The doll portion 46 is shaped to stand upright from the foot portion 45 by its two legs. The protruding portion 43b is fitted in the recess 45a and thus the body portion 42 is fixedly mounted to the top portion 43a of the pedestal portion 41. Each individual FIG. 40 is subtly varied in color tone even if the character is the same. Alternatively, data unique to (characterizing) each character is made different between different characters. In this way, the uniqueness of each character is represented. This promotes players' will to collect game articles. The FIG. 40 is contained in the capsule 47 and held in the accommodation unit 3.

The capsule 47 has two semispherical shell-like portions which can be separated from each other and combined into one spherical body. If the two semispherical shell-like portions are combined into one, a hollow spherical body having a diameter of about 7 cm is obtained. The FIG. 40 is put into it.

(Contents of Operation of Game Article Supply Apparatus)

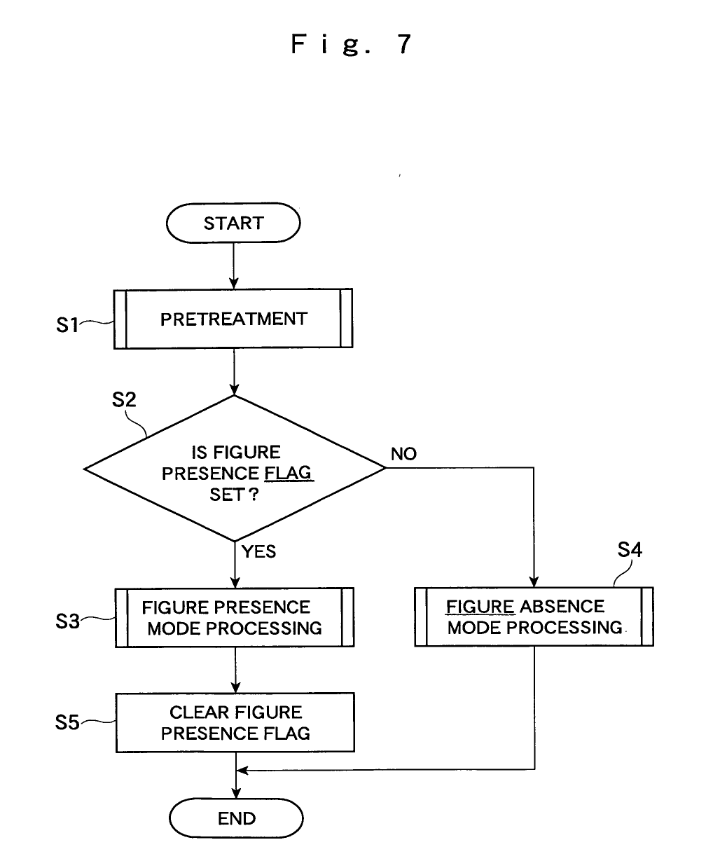

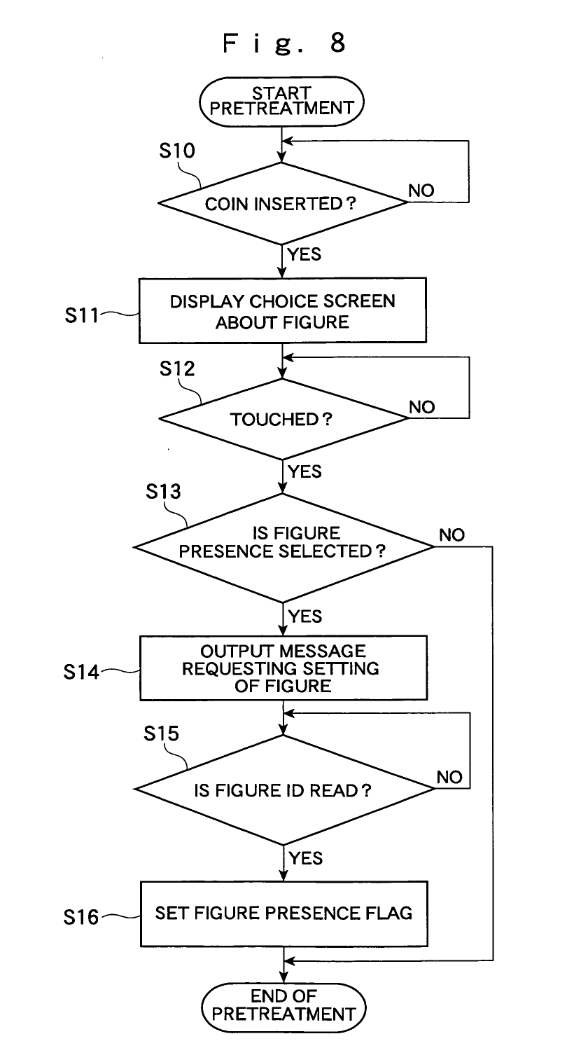

The contents of operation of the game article supply apparatus 1 constructed as described so far are next described with reference to the flowcharts shown in FIGS. 7-10. FIG. 7 is a flowchart illustrating a procedure for operations from start to end of processing in the game article supply apparatus 1. In FIGS. 7 and in FIGS. 8-10 (described later), a process step is abbreviated S.

When a player who wants to purchase the FIG. 40 inserts a coin or coins into the coin insertion port 8 to pay for the FIG. 40, the game article supply apparatus 1 operates as follows.

When the apparatus 1 for supplying a game article commences its operation, control goes to step 1, where a pretreatment (described later) including a decision as to whether there is an insertion of a coin and a decision as to where there is a figure is carried out. In step 2, a decision is made from the result of the pretreatment as to whether given data is set to a figure presence flag (described later) (whether the flag is set or not) According to the decision, control goes to step 3 or step 4, i.e., a branch is made. In particular, if the figure presence flag is set, control proceeds to step 3. If not so, control goes to step 4. Either process step is performed. In step 5 following step 3, the figure presence flag is cleared, thus ending the operation.

(Pretreatment)

The game article supply apparatus 1 performs the pretreatment along the flowchart shown in FIG. 8, which illustrates a procedure for operations of the pretreatment.

When the pretreatment is started, the game article supply apparatus 1 goes to step 10 shown in FIG. 8. The apparatus waits until a player inserts a coin. When the correct amount of coin is inserted, control proceeds to step 11, where a choice screen for asking whether the player possesses a figure or not is displayed on the display unit 9. In the subsequent step 12, the apparatus waits until the player touches the touch panel 9a. If it is touched, control goes to step 13. A decision is made as to whether the user has selected “there is a figure” in step 11. If “there is a figure” is selected, control goes to step 14. If not so, the pretreatment is ended.

In step 14, a message requesting setting of a figure is output. That is, the image control circuit 29 is operated to display a message on the display unit 9 to request the user to set the FIG. 40 on the authentication unit 7 for reading the figure ID. For example, the message is “please set the pedestal of the figure in the authentication unit”. In the next step 15, the apparatus waits until reading of the figure ID is completed. If the player obeys the displayed message and sets the FIG. 40 in the authentication unit 7, the unit 7 reads the figure ID stored in the IC chip 44 of the set FIG. 40. In the next step 16, the main CPU 21 operates as the setting portion in the present invention and sets the figure presence flag into the RAM 22. If given data (“1” in the present embodiment) is set to the set figure presence flag, the pretreatment is ended. The figure presence flag indicates whether the figure ID of the FIG. 40 has been read by the authentication unit 7. The figure presence flag corresponds to the indication information in the present invention.

(Processing Performed when there is a Figure)

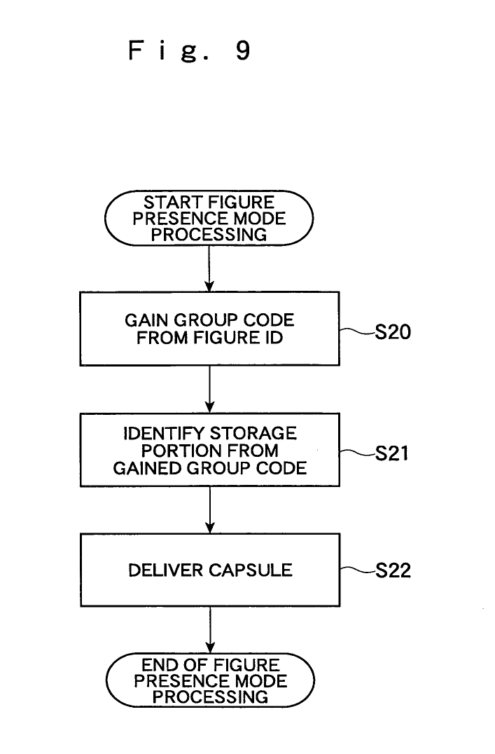

The game article supply apparatus 1 performs processing to be effected when there is a figure, along the flowchart illustrated in FIG. 9, which illustrates a procedure for operations of the processing performed when there is a figure. This processing may be herein referred to as the “figure presence mode processing”.

When the figure presence mode processing is started, the game article supply apparatus 1 goes to step 20 shown in FIG. 9. The main CPU 21 gains a group code from the figure ID read in the step 15 of FIG. 7. That is, the CPU derives any one of group codes A, B, and so on from any one of figure IDs “A001”, “B001”, and soon. “001” following a group code indicates the kind of the figure. In the next step 21, the microcomputer 20 operates as the identification portion in the present invention, refers to the relationship table, and identifies the accommodation portion 10 corresponding to the group code gained in step 20 from among the accommodation portions 10 as an accommodation portion (hereinafter referred to as the “target accommodation portion”) in which the figure to be delivered is accommodated. A figure which is identical in character and group code with the figure whose figure ID has been read but which is wearing a different costume or carries weapon is accommodated in the identified accommodation portion 10. That is, a figure of a different kind is accommodated.

Control then goes to step 22, where a capsule 47 is delivered from the target accommodation portion 10 identified in the step 21 out of the accommodation portions 10. That is, the main CPU 21 operates as the delivery control portion and outputs an opening control signal to the drive control circuit 31 to open the shielding plate 15 (e.g., shielding plate 152) of the target accommodation portion 10 such that the figure accommodated in the target accommodation portion 10 is delivered. The drive control circuit 31 drives the motor (e.g., motor M2) corresponding to the opening control signal, opening the shielding plate 152. Then, the capsule 47 located closest to the shielding plate 15 on the slope 12a rolls out of the delivery port 14. As shown in FIG. 3, the capsule passes through the discharge path 16 and is delivered into the capsule takeout port 6.

As described so far, with the game article supply apparatus 1, by setting the FIG. 40 possessed by the player on the authentication unit 7 and reading the figure ID, a figure of a character having the same group code as the read FIG. 40 (i.e., a figure belonging to the same group) can be supplied.

In this way, there are plural accommodation portions 10 for each of the plural group codes and so plural figures accommodated in each accommodation portion 10 can be easily managed such that a figure of the same kind is supplied at a reduced probability. Accordingly, the possibility that figures of the same kind are supplied duplicately can be reduced. This can sustain players' will to collect game articles.

In addition, there is no danger that a figure not associated with the FIG. 40 already possessed by the player is delivered. Consequently, the player's will to collect figures can be sustained further.

(Processing Performed in Cases where there is No Figure)

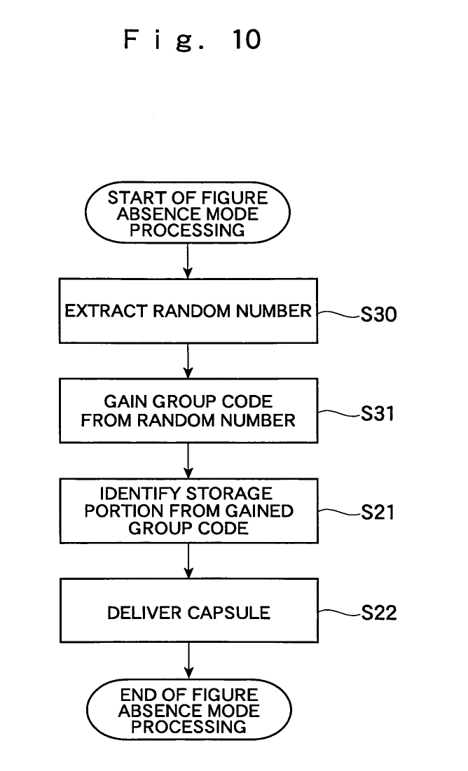

On the other hand, the game article supply apparatus 1 performs processing to be carried out when there is no figure along the flowchart shown in FIG. 10. FIG. 10 is a flowchart illustrating a procedure for operations of processing to be performed in cases where there is no figure. This processing may be herein referred to as the “figure absence mode processing”. The figure absence mode processing is carried out when given data is not set to the figure presence flag, i.e., when the figure presence flag indicates that no figure ID has been read. This is based on the assumption that the player possesses no figure (e.g., when the player buys a figure for the first time).

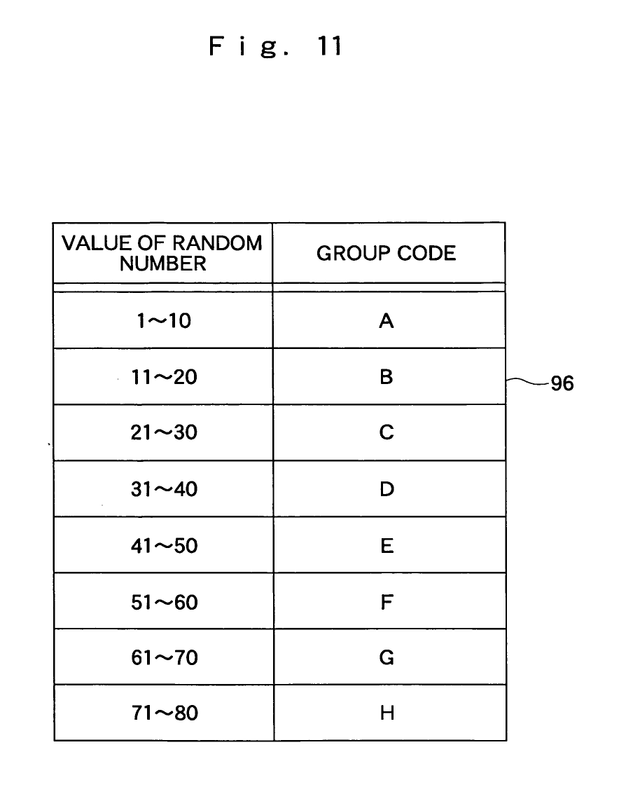

When the game article supply apparatus 1 starts the figure absence mode processing, control goes to step 30 shown in FIG. 10. The main CPU 21 instructs the random number generator 25 to produce random numbers (1-80 in the present embodiment). The main CPU also instructs the sampling circuit 26 to extract an arbitrary random number from among the random numbers produced by the random number generator 25. In the following step 31, the random number extracted in the step 30 is set to the search key. The group code table 96 shown in FIG. 11 is searched for a group code corresponding to the random number. This group code is obtained. In the table, various random numbers and their associated group codes are accommodated in an interrelated manner. For example, where the random number generated by the random number generator 25 is “15”, group code B is gained by referring to the group code table 96 shown in FIG. 11. The following steps 21 and 22 are carried out in the same way as in the figure presence mode processing. The capsule 47 is delivered to the capsule takeout port 6.

Where the player possesses no figure, the game article supply apparatus 1 can select the figure absence mode processing in this way. Even where there is no figure, the target accommodation portion is identified by lottery out of random numbers, and a figure accommodated in this target accommodation portion is delivered. Therefore, if the player has no figure, he or she can buy a figure.

### Second Embodiment

Embodiment of a Game Article Supply System

(Whole Configuration of Game Article Supply System)

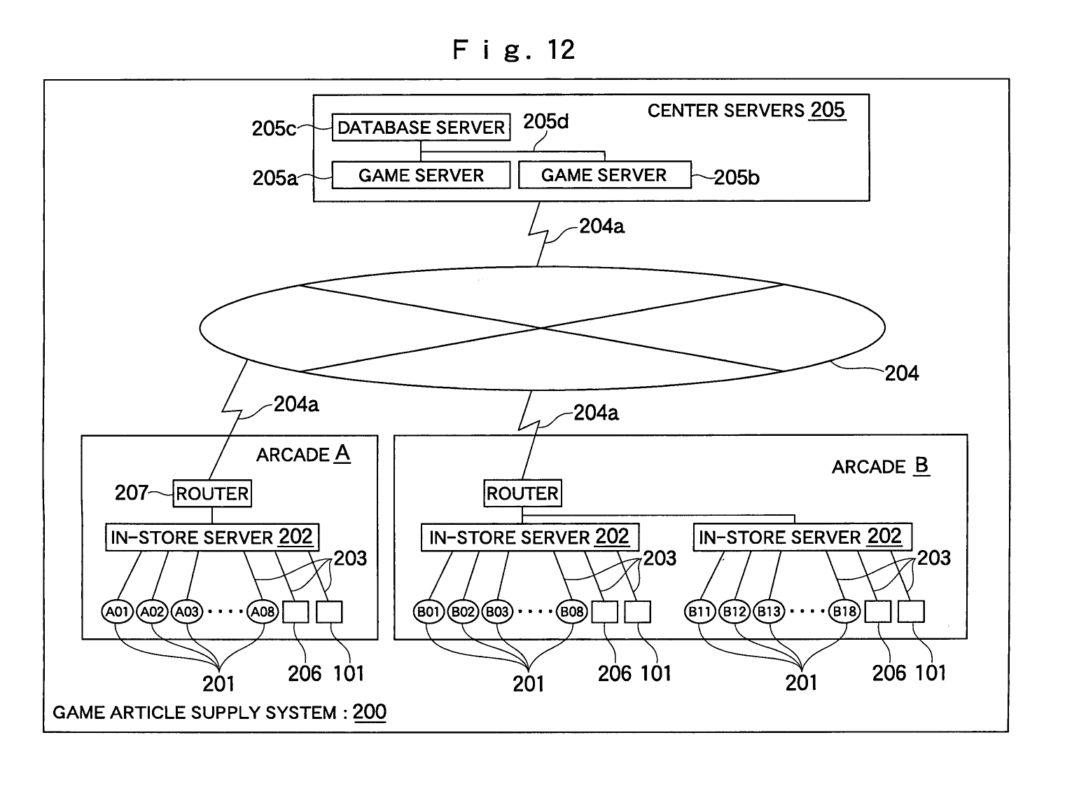

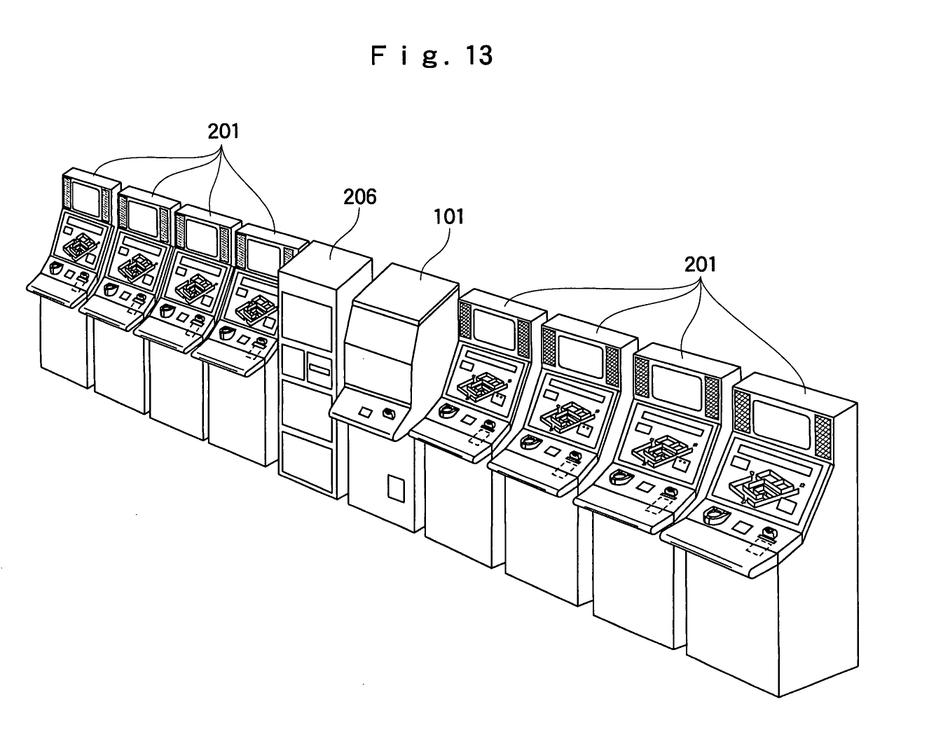

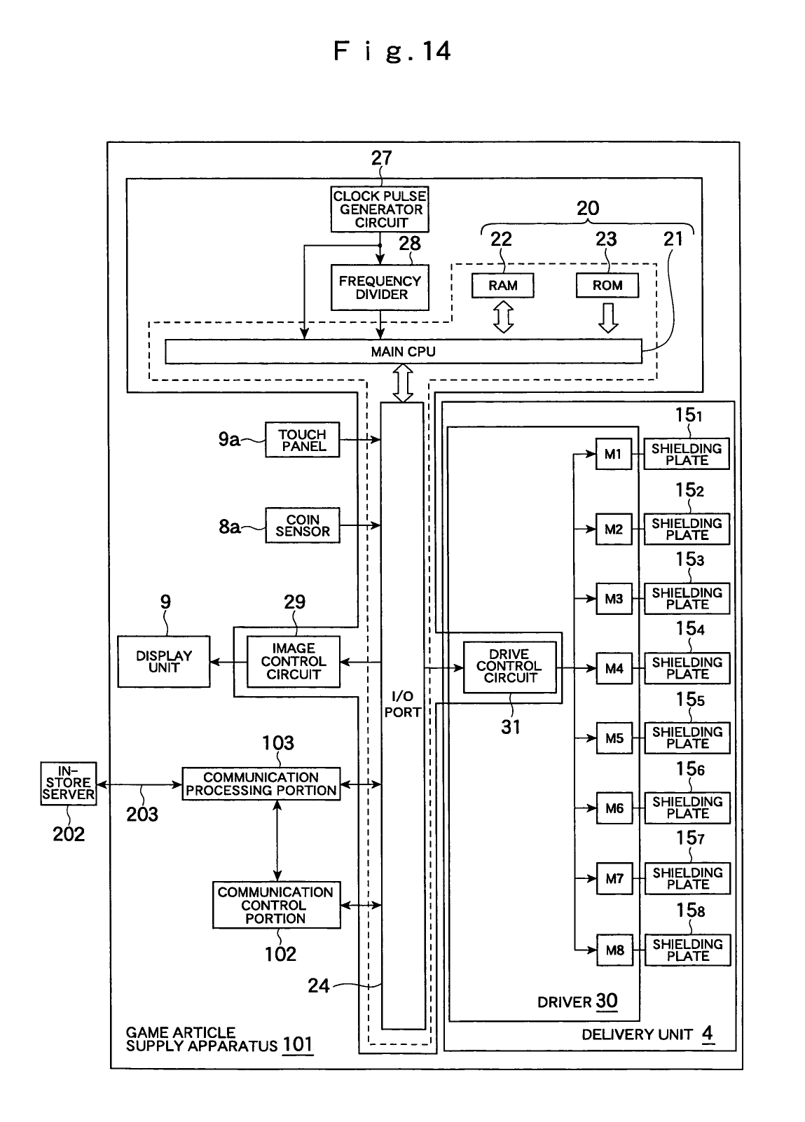

FIG. 12 is a system diagram showing a game article supply system 200 equipped with a game article supply apparatus 101 and plural game machines 201. FIG. 13 is a perspective view showing the game article supply apparatus 101, game machines 201, and a card vending machine 206. FIG. 14 is a block diagram of the game article supply apparatus 101, mainly showing the internal structure.

The game article supply system 200 has three in-store servers 202 (one server for an arcade A and two servers for another arcade B), the game article supply apparatus 101 communicably connected via a dedicated line 203, the plural (eight in the present embodiment) game machines 201, card vending machine 206, in-store rooters 207 installed in the arcades A and B, and center servers 205 connected via the in-store rooters 207, a communication line 204a, and the Internet 204.

In each of the arcades A and B, the in-store server(s) 202, game article supply apparatus 101, game machines 201, and card vending machine 206 are connected by the dedicated line 203 to thereby form an in-store LAN (local area network). This in-store LAN is connected with the Internet 204 via the in-store router 207.

(Configuration of Game Article Supply Apparatus)

The game article supply apparatus 101 is similar in configuration with the aforementioned game article supply apparatus 1 except that the authentication unit 7, random number generator 25, and sampling circuit 26 are omitted but a communication control portion 102 and a communication processing portion 103 are added, as shown in FIGS. 13 and 14.

The communication control portion 102 in the game article supply apparatus 101 operates according to instructions from the main CPU 21 and controls connection and disconnection of the network for making communications with the in-store server 202. The communication processing portion 103 operates according to instructions from the communication control portion 102 and performs sending and reception of data via the dedicated line 203.

(Configuration of Game Machines)

Each game machine 201 is a game unit constituting the game article supply system 200 of the present invention. The game machine has an image display portion for displaying images of a character made to act according to player's manipulations as game images used in a game. The game machine is designed to play an image game in which a character is made to act according to player's manipulations. With the game machine 201, a labyrinth combat game can be played. That is, the player's character can combat with a character of other person (i.e., player character made to perform actions according to choices made by the other player) or with a non-player character made to perform actions by the game machine while the player's character moves along the labyrinth along the route selected by the player. Each character struggles for items possessed by the characters, collects all the items, and then knocks down the final target character. In this labyrinth combat game, the score of each character (referred to as the “life” in the present embodiment) is increased or decreased according to the results of the combat or progress of the game. The character whose score has decreased down to 0 is regarded as a loser.

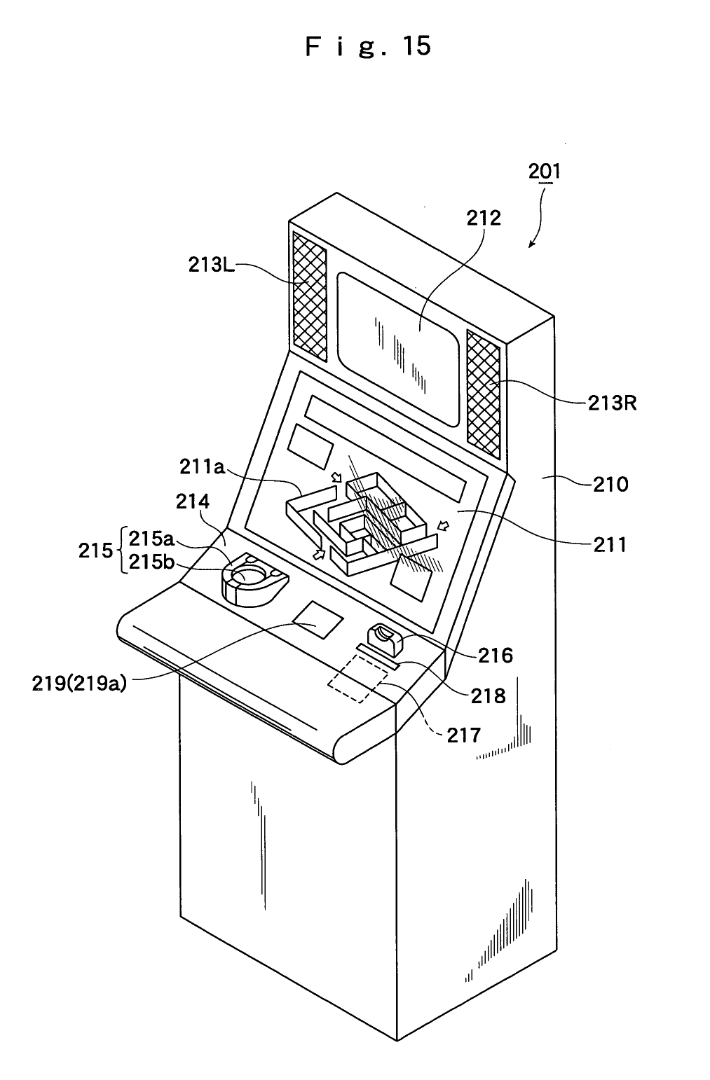

As shown in FIG. 15, each game machine 201 has a main display 211 equipped with a liquid crystal display on the front of its housing 210. A secondary display 212 similarly equipped with a liquid crystal display is mounted over the main display 211. Speakers 213L and 213R are disposed on both sides of the secondary display to output speech used for rendering of the game.

Images of the game at various stages of the game (e.g., a labyrinth image 211a) are displayed on the main display 211. An image at a certain stage of the game is displayed on the secondary display 212.

The game machine 201 has a control panel 214 under the main display 211. An authentication unit 215 is disposed on the left of the control panel 214. A coin insertion port 216 for inserting a coin necessary when the game is executed or when a figure is purchased and a card slot 218 for inserting an ID card 217 are formed to the right. The game machine further includes a control display unit (CDU) 219 equipped with a liquid crystal display on which a choice screen for asking the user whether there is a FIG. is displayed. A touch panel 219a (see FIG. 15) is mounted to cover the display screen of the CDU 219.

The authentication unit 215 is the reading portion in the present invention and has a pedestal-mounting portion 215a and a reading portion 215b. This authentication unit is similar in configuration with the authentication unit 7 of the aforementioned game article supply apparatus 1.

An intrinsic machine ID is attached to each game machine 201 forming the game article supply system 200. The machine ID has a server ID intrinsic to each in-store server 202 and an ID intrinsic to each game machine 201.

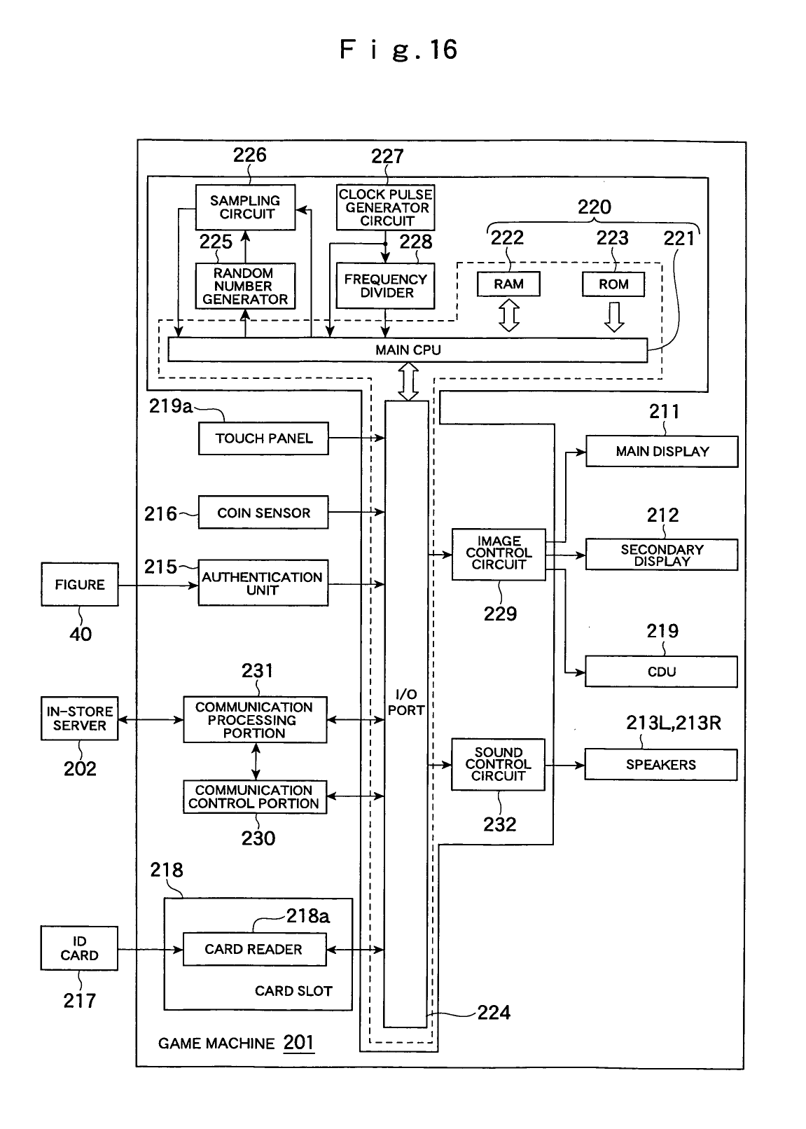

FIG. 16 is a block diagram of one game machine 201, mainly showing its internal structure. The game machine 201 consists mainly of a microcomputer 220, together with other components.

The microcomputer 220 has a main CPU (central processing unit) 221, a RAM (random access memory) 222, and a ROM (read only memory) 223. The main CPU 221 operates according to a program stored in the ROM 223. Signals from various components mounted on the control panel 214 are entered into the main CPU via an I/O port 224. At the same time, the main CPU exchanges signals with other components. Thus, the main CPU controls the operation of the whole game machine 201. Data and programs (application data and game data (described later) in the present embodiment) used when the main CPU 221 operates are stored in the RAM 222. A control program executed by the main CPU 221 and permanent data are stored in the ROM 223.

The game machine 201 has a random number generator 225, a sampling circuit 226, a clock pulse generator 227, and a frequency divider 228. The random number generator 225 operates under instructions from the main CPU 221 and produces a certain range of random numbers. The sampling circuit 226 extracts an arbitrary random number from among random numbers produced by the random number generator 225 under instructions from the main CPU 221 and feeds the extracted random number to the main CPU 221. The clock pulse generator circuit 227 produces reference clock pulses for operating the main CPU 221. The frequency divider 228 supplies a signal obtained by frequency-dividing the reference clock pulses by a given period to the main CPU 221.

Furthermore, the game machine 201 has a coin sensor 216a, a card reader 218a, a communication control portion 230, and a communication processing portion 231. In addition, the machine has an image control circuit 229 and a sound control circuit 232.

The coin sensor 216a detects a coin inserted from the coin insertion port 216 and outputs an output signal corresponding to the detection to the main CPU 221. The card reader 218a reads card information such as a player ID recorded on the ID card 217 inserted into the card slot 218 and feeds the read card information into the main CPU 221.

The communication control portion 230 operates according to instructions from the main CPU 221 and controls connection and disconnection of the network for making communications with the in-store server 202. The communication processing portion 231 operates according to instructions from the communication control portion 230 and performs sending and reception of data via a dedicated line 203.

The image control circuit 229 controls images displayed on the main display 211, secondary display 212, and control display unit (CDU) 219 and displays various images on these display units 211, 212, and 219. These various images include images indicating characters and a choice screen for selecting whether there is a figure or not.

The sound control circuit 232 enters speech signals for outputting speech from the speakers 213L and 213R to the speakers 213L and 213R. Speech is output from the speakers 213L and 213R, for example, to liven up the game at appropriate time after the start of the game.

(Configuration of In-Store Servers, Card Vending Machines, and In-Store Routers)

Each in-store server 202 has a CPU, a ROM, a RAM, a communication processing portion, a communication control portion, and a data storage portion in which application data is stored. The CPU operates while reading and writing data to and from the RAM according to the program stored in the ROM. Meanwhile, the communication control portion operates the communication processing portion according to instructions from the CPU. The in-store server 202 sends and receives data to and from the game article supply apparatus 101, game machines 201, and card vending machine 206 installed in the arcades A and B via the dedicated line 203. The in-store server sends application data to the game machines 201 such that the data is downloaded into the game machines. Furthermore, the in-store server relays data when data is exchanged between the game article supply apparatus 101 or between the game machines 201. In addition, the in-store server relays data when the center servers 205 send and receive data. The application data includes various kinds of data (such as image data for a game) used in executing a labyrinth combat game played on the game machines 201 and data for the board (setting program for making the manipulation buttons displayed on the control display unit (CDU) 219 correspond to the labyrinth combat game).

Each card vending machine 206 has a manipulation portion permitting a player to perform an entry operation for inputting personal information and a card issuance portion. When the given entry operation using the manipulation portion is performed, the card issuance portion stores card information including the player ID intrinsic to each individual player and issues an ID card 217.

Each in-store router 207 connects the in-store LANs formed in the arcades A and B with the LAN formed among the center servers 205 via the communication line 204a and the Internet 204.

(Configuration of Center Servers)

The center servers 205 have plural game servers (2 game servers 205a and 205b in FIG. 12) installed in a corresponding manner to individual games and a database server 205c. The game servers are interconnected via a dedicated line 205d to form a LAN, which in turn is connected with the Internet 204 via a router (not shown).

The game server 205a is installed to execute a labyrinth combat game and has a CPU, a ROM, a RAM, a communication processing portion, a communication control portion, and a data storage portion. In the game server 205a, the CPU operates while reading and writing data to and from the RAM in accordance with the program stored in the ROM. Meanwhile, the communication control portion operates the communication processing portion according to instructions from the CPU.

The game server 205a sends and receives data via the in-store servers 202 and the Internet 204. The game server 205a receives entry data sent from each game machine 201, accepts participation (entry) of the player in the labyrinth combat game, and updates information about participation of players. The server determines the player who will be the opponent in the game. The result is sent to the database server 205c.

The game server 205b is installed to execute another game. This server is different in stored data and program from the game server 205a but identical in configuration.

The database server 205c has a CPU, a ROM, a RAM, a communication processing portion, a communication control portion, and a data storage portion. In the database server 205c, the CPU operates while reading and writing data to and from the RAM in accordance with the program stored in the ROM. Meanwhile, the communication control portion operates the communication processing portion according to instructions from the CPU and sends and receives data via the in-store servers 202 and the Internet 204. IDs of players, passwords used for authentication of players, kinds of games, and game data are stored in the data storage portion. Each game machine 201 reads a player ID from the ID card 217 and sends it.

When each player sets a FIG. 40 to be used by himself or herself in the authentication unit 215 in the game machine 201, the figure ID is read. The figure ID corresponding to the read FIG. 40 is sent from the game machine 201 to the database server 205c. In the database server 205c, an ID management file in which one player ID sent from the game machine 201 can be stored in association with corresponding plural figure IDs is formed in the data storage portion. The player and the figure used by the player are managed by the ID management file.

The game data includes data featuring each character appearing in the labyrinth combat game and data indicating the history of the labyrinth combat game played by each player. The data featuring (intrinsic to) each character includes information (hereinafter referred to as “figure information”) indicating the costume of the character, the color of the costume, values indicating the capability of the character (such as protective parameters, offensive parameters, and attack range), and information indicating special capability. The game data is sent to the game machine 201 from the database server 205c and used in the labyrinth combat game.

(Contents of Operations of Game Article Supply Apparatus and Game Machines)

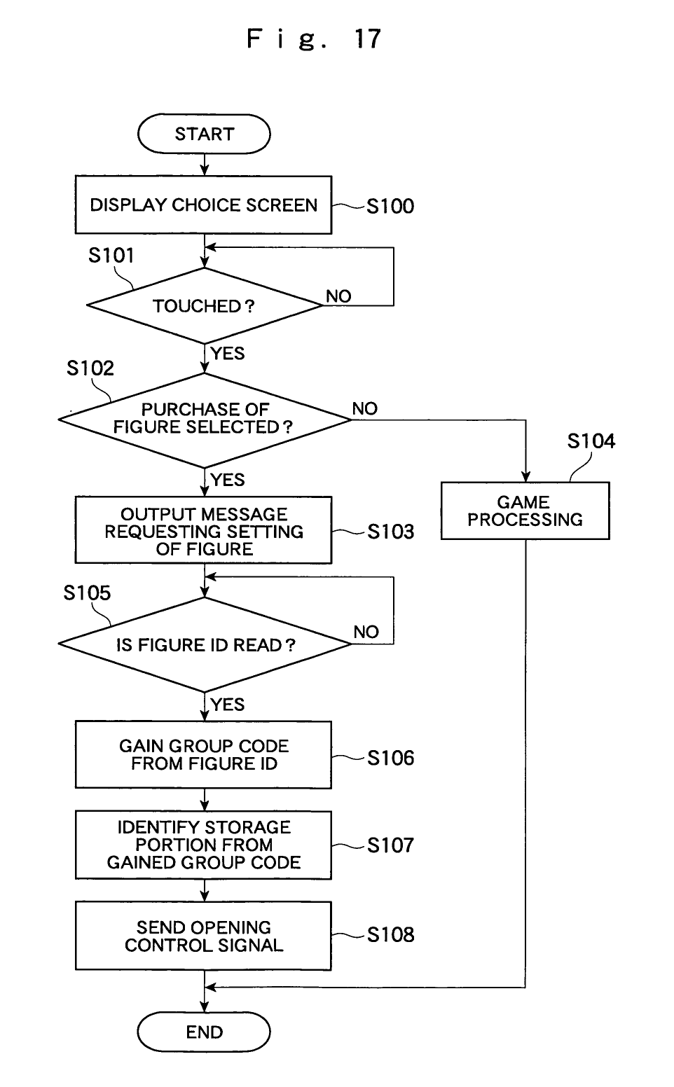

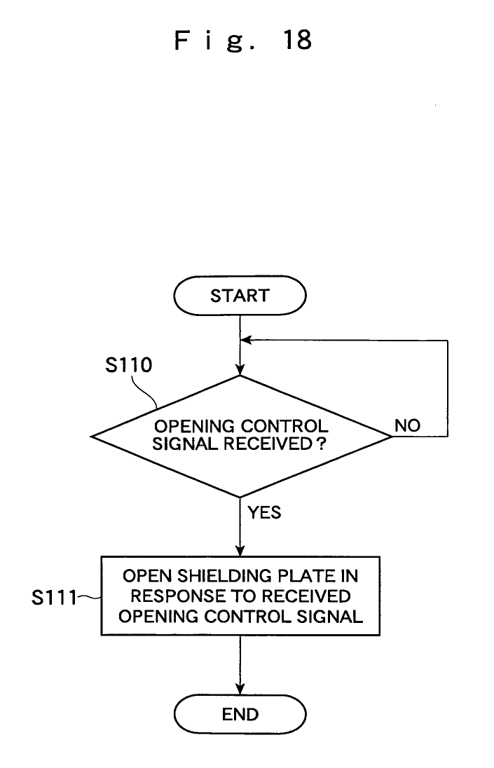

The contents of operations of the game article supply apparatus 101 and game machines 201 constructed as described so far are next described principally in relation to the operation to deliver each capsule 47. FIG. 17 is a flowchart illustrating the control of the delivery from start to end of the processing performed in the game machine 201 and a procedure for operations for processing a game. In FIGS. 17 and 18 (described later), each process step is abbreviated S.

When the control of delivery and processing of the game are started, the game machine 201 goes to step 100, where a mode selection screen for prompting the user to select between purchase of a figure and start of the game is displayed on the control display unit 219. In the next step 101, the program waits until the player touches the touch panel 219a. If it is touched, control goes to step 102, where a decision is made as to whether the player has selected the purchase of a figure on the mode selection screen. If the purchase of a figure is selected, control goes to step 103. On the other hand, if start of the game is selected, control proceeds to step 104, where processing of the game is performed. At this time, processing necessary to execute the labyrinth combat game is performed. The operation of the game machine 201 ends.

In the step 103, a message prompting the user to set a figure is output. That is, the image control circuit 229 operates according to instructions from the main CPU 221. A message prompting the user to set the FIG. 40 is output in the same way as in step 14. In the next step 105, the program waits until reading of the figure ID is completed. If the player sets the possessed FIG. 40 in the authentication unit 215 of the game machine 201, the authentication unit 215 reads the figure ID stored in the IC chip 44 of the set FIG. 40, and then control goes to step 106. In the step 106, the group code contained in the figure ID read in the step 105 is gained. If control goes to step 107, the main CPU 221 operates as the identification portion in the present invention, refers to the relationship table, and identifies the accommodation portion 10 corresponding to the group code gained out of all the accommodation portions 10 as a target accommodation portion 10. Control then goes to step 108, where the main CPU 221 operates as the delivery control portion in the present invention and activates the communication control portion 230 and the communication processing portion 231 to send an opening control signal to the game article supply apparatus 101, for opening the shielding plate 15 of the target accommodation portion 10. Thus, the FIG. 40 accommodated in the target accommodation portion 10 is delivered. When the step 108 is executed, the operation of the game machine 201 ends.

On the other hand, the game article supply apparatus 101 performs processing for delivery of a figure along the flowchart illustrated in FIG. 18. When the processing for the delivery of a figure is started, the game article supply apparatus 101 goes to step 110, where the program waits until the opening control signal sent from the game machine 201 is received. When the opening control signal is received, control goes to step 111, where the main CPU 21 instructs the drive control circuit 31 to operate the corresponding motor according to the opening control signal received by the communication processing portion 103, thus opening the shielding plate 15. The capsule 47 located closest to the opened shielding plate 15 rolls out of the delivery port 14 and is delivered into the capsule takeout port 6. After execution of step 112, the processing for delivery of a figure ends.

As described so far, in the game article supply system 200 having the game article supply apparatus 101 and the plural game machines 201, the player can select a figure purchase mode, in addition to start of a game on the game machine 201. If the player selects the figure purchase mode, the player sets the FIG. 40 in the authentication unit 215, causing it to read the figure ID. As a result, a figure which belongs to the same group as the possessed FIG. 40 but which is of a different kind, if possible, is supplied to the player. This can sustain the player's will to collect game articles. Additionally, there is no possibility that a figure not associated with the FIG. 40 already possessed by the player is delivered. Hence, the player's will to collect figures can be sustained further.

(Others)

In the embodiments described so far, a figure belonging to the same group as the figure read with the authentication unit is delivered using a group code. Alternatively, the capsule containing figures of characters simulating the shapes of monsters or the like or figures having figure information in which the values of the performance of the characters or special abilities (hereinafter referred to as rare figures) have been enhanced may be accommodated in some accommodation portions 10. The rare figures may be delivered.

In particular, 8 kinds of figures including normal figures having group codes A1-D1 and rare figures having group codes A2-D2 are accommodated in the accommodation portions 10 of the game article supply apparatus 1 and 101. The normal figures are figures of characters simulating persons or figures whose values of abilities or special abilities are set lower than those of the rare figures. The normal figures of group codes A1-D1 correspond to the rare figures of group codes A2-D2, respectively. For instance, the rare figure of group code A2 is located at a higher category than the normal figure of group code A1. In this modified embodiment, too, the group codes A1-D1 and A2-D2 are contained in some of the figure IDs stored in the IC chip 44 possessed by the figure.

Where the player possesses any one of the normal figures, if the normal figure is set in the authentication unit 7 or 215, the figure ID is read and a group code (any one of A1-D1) is gained. A relationship table (not shown) in which the group codes of the normal figures and the group codes of the rare figures are stored in an interrelated manner is referenced. A group code (any one of A2-D2) of the corresponding rare figure is gained. In this way, the accommodation portion in which the rare figure corresponding to the normal figure is accommodated is set as the target accommodation portion. Consequently, the rare figure can be delivered.

Furthermore, when a group code (any one of A1-D1) is gained by reading the figure ID of a normal figure, it may be determined by lottery out of random numbers as to whether the relationship table is referenced or not. For example, random numbers from 1 to 100 may be produced, and the following scheme may be adopted. Where the extracted random number is any one of 1-80, the accommodation portion corresponding to the group code (any one of A1-D1) of the normal figure which is gained without referring to the relationship table is set as the target accommodation portion. For example, where the extracted random number is any one of 81-100, the relationship table is referenced. The accommodation portion corresponding to the group code (any one of A2-D2) of the rare figure is set as the target accommodation portion. In this way, normal figures can be delivered at a probability of 80% and rare figures can be delivered at a probability of 20%.

On the other hand, in a case (not shown) where the player possesses no figure, an arbitrary random number is extracted from among random numbers produced by the random number generator 25 or 225. In this way, any one of the accommodation portions 10 in which normal figures are accommodated is identified as a target accommodation portion, and any normal figure is delivered.

While one embodiment of the game article supply apparatus and game article supply system of the present invention has been described in detail, the invention is not limited thereto. Rather, various changes and modifications are possible. That is, in the above-described game article supply apparatus 1, the FIG. 40 is taken as an example of a game article. The present invention can also be applied to a case where a game article different from the FIG. 40 is supplied. For example, game cards, card-like game tokens, or cassettes which bear pictures or patterns corresponding to characters and which store ID information and other information may be delivered.

When the FIG. 40 is being read, the authentication unit 7 or 215 may inform the player that the figure ID is being read by illuminating the FIG. 40 with light with LEDs.

Furthermore, a figure that is a variation of the same kind or rare figure may be delivered only in the case where the score obtained by the game or the degree of achievement of the game indicates that the game has progressed at least to a certain level after referring to data indicating the history of the labyrinth combat game played by players, the data being stored in the database server 205c.

In addition, a capsule containing a part that the authenticated figure can wear such as a weapon or protector may be delivered. Furthermore, this part may be worn on the figure to improve the value indicative of the character capability or figure information such as special capability.

Although each game machine 201 is equipped with the main display 211 for displaying images for a game and with the secondary display 212, the main display 211 and the secondary display 212 may be mounted as separate units.

In the description of the above embodiment, the microcomputer 220 of each game machine 201 acts as the identification portion and also as the delivery control portion. Alternatively, the program executed by each in-store server 202 may be so configured that the CPU of the in-store server 202 operates as the identification portion. In this way, a game article supply system may be built. Moreover, a game article supply system may be built by installing an apparatus which is identical in functions with the aforementioned various portion, apart from the game machines 201 and in-store servers 202.

### Third Embodiment

### Other Embodiment of Game Article Supply Apparatus

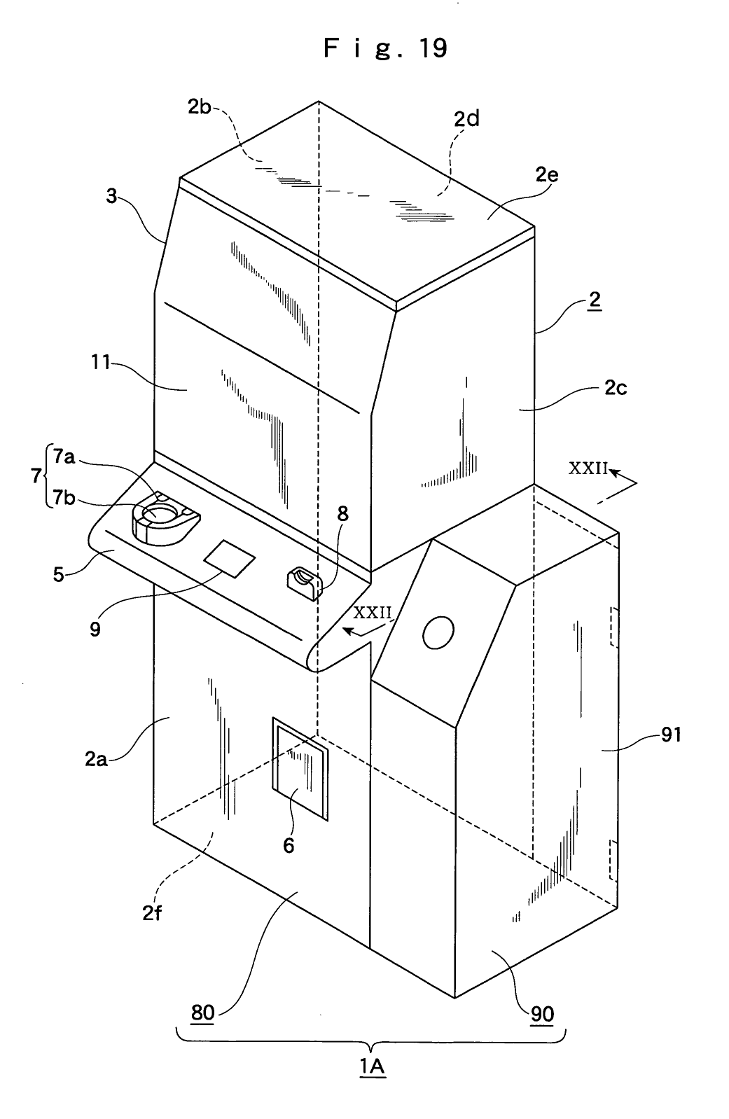

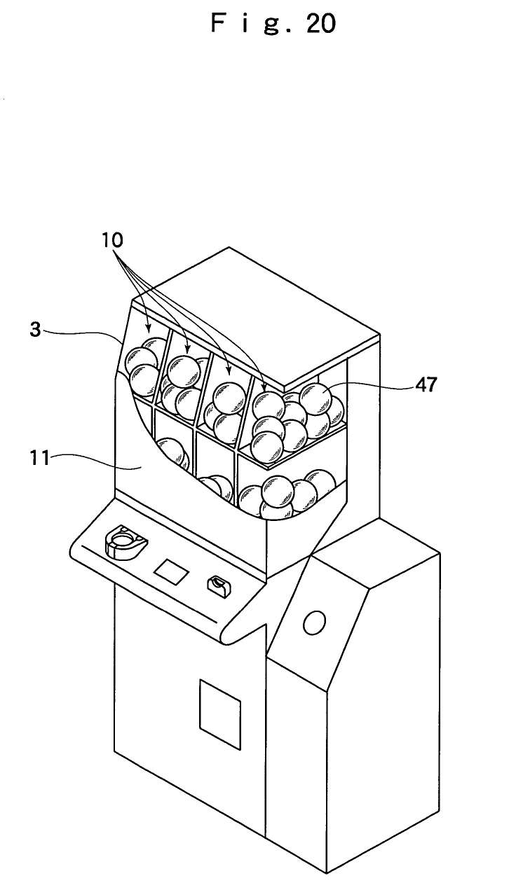

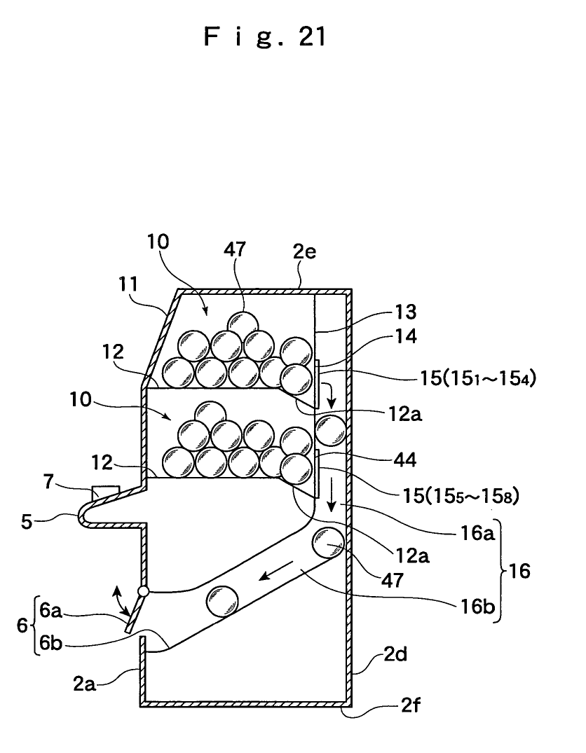

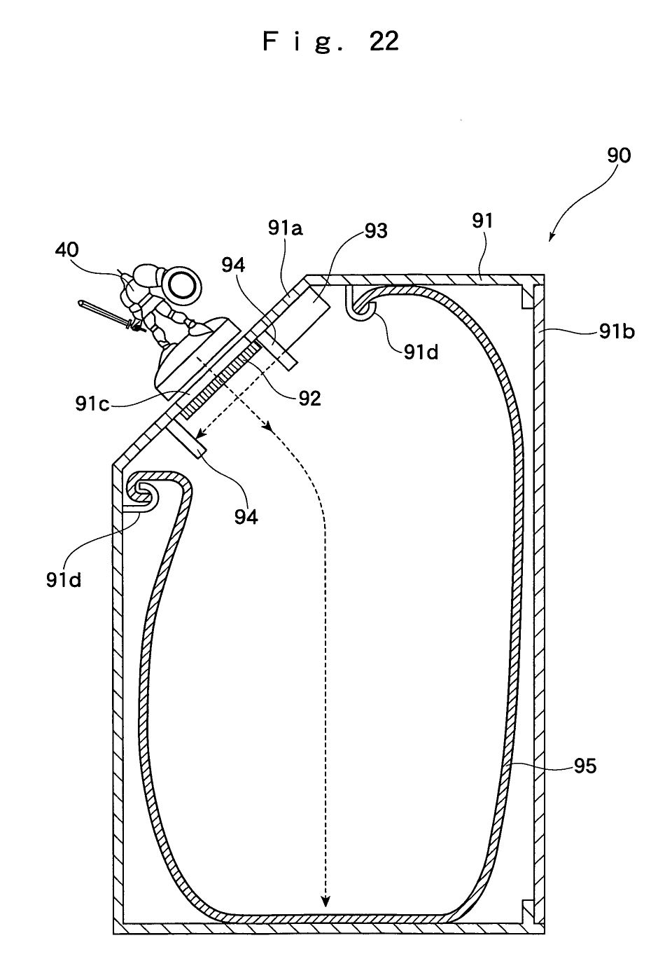

FIG. 19 is a perspective view showing the whole configuration of a game article supply apparatus 1A associated with a third embodiment of the present invention. The apparatus 1A is designed to be able to recover game articles. Indicated by 80 is a unit for supplying a game article. A recovery unit 90 is used to recover a game article. FIG. 20 is a partially cutaway perspective view of the game article supply apparatus 1A. FIG. 21 is a side elevation, schematically showing main portions of the game article supply apparatus 1A. FIG. 22 is a cross-sectional view taken on line XXII-XXII of the recovery unit 90 in FIG. 19.

The game article supply apparatus 1A of the present embodiment is similar in configuration with the game article supply apparatus 1 shown in the first embodiment except that the recovery unit 90 has been added. Therefore, those portions of FIGS. 19-22 which correspond to their counterparts shown in FIGS. 1-3 are denoted by the same numerals as in FIGS. 1-3 and their description is omitted.

(Configuration of Recovery Unit)

The recovery unit 90 is the acceptance portion in the present invention. As shown in FIGS. 19 and 22, the unit 90 has a housing 91, an open-close plate 92, an open-close drive unit 93, and a recovery detection sensor 94. The recovery unit 90 can accept and recover a FIG. 40 from the outside. The housing 91 has a height about half of the height of the supply unit 80, and is shaped like a rectangular box. A tilted portion 91a is formed in a front portion located between the front panel and the top panel. The open-close plate 92, the open-close drive unit 93, and the recovery detection sensor 94 are accommodated inside the tilted portion 91a. Furthermore, the housing 91 has an open-close door 91b on its rear side. A hook 91d is formed on the inside of the housing 91. The recovered FIG. 40 can be inserted into a figure recovery bag 95 by opening the open-close door 91b of the housing 91 and causing the recovery bag 95 made of a vinyl bag to be caught on the hook 91d.

The tilted portion 91a is substantially centrally provided with a circular opening 91c of the size corresponding to a pedestal portion 41 (described later) of the FIG. 40. The open-close plate 92, open-close drive unit 93, and recovery detection sensor 94 are disposed inside the tilted portion 91a.

The open-close plate 92 is appropriately larger than the opening 91c. The open-close plate 92 is opened and closed by the open-close drive unit 93. Thus, the opening 91c is opened and closed from inside the housing 91. The open-close drive unit 93 has a drive motor, a driver circuit for the drive motor, and a mechanism for opening and closing the open-close plate 92. The open-close plate 92 is opened and closed according to an instruction from the main CPU 21 in a manner described below. The recovery detection sensor 94 has a light-emitting portion and a light-receiving portion. A detection is made as to whether the FIG. 40 has entered through the opening 91c from the outside depending on whether light produced from the light-emitting portion is received by the light-receiving sensor. When entry of the figure is detected (i.e. the figure has been accepted), a recovery detection signal is entered into the main CPU 21.

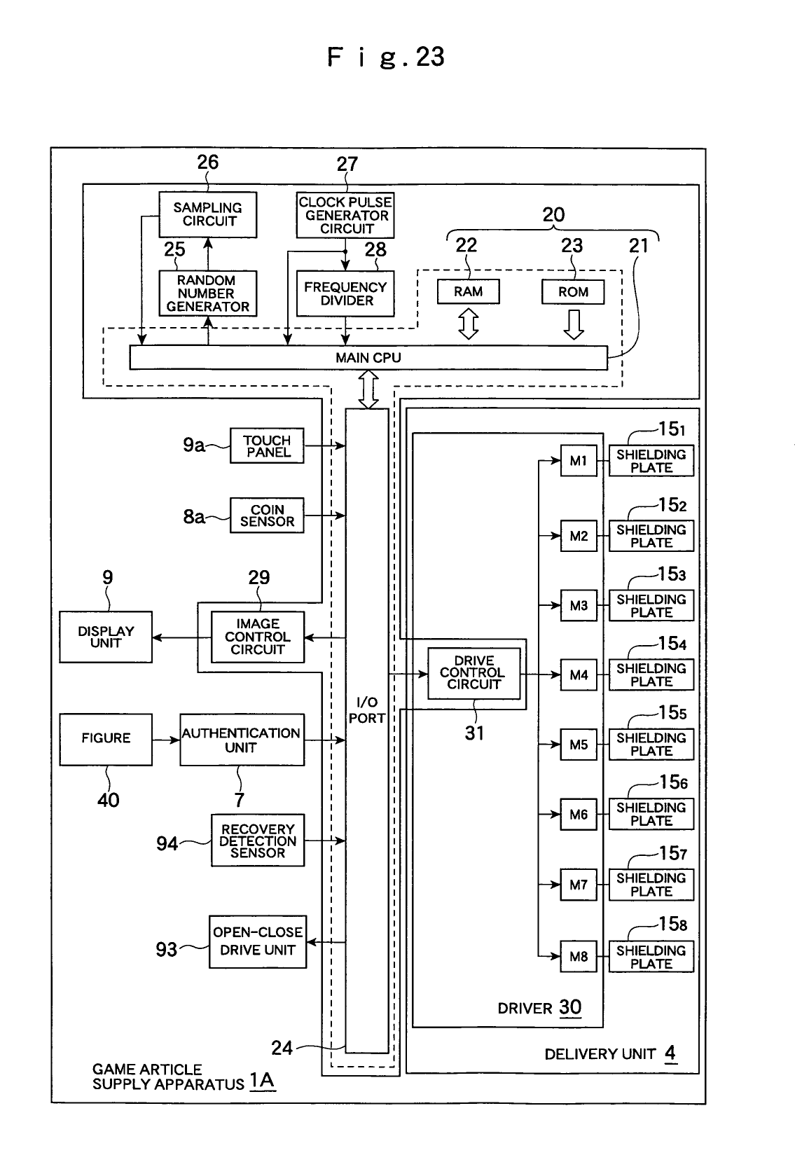

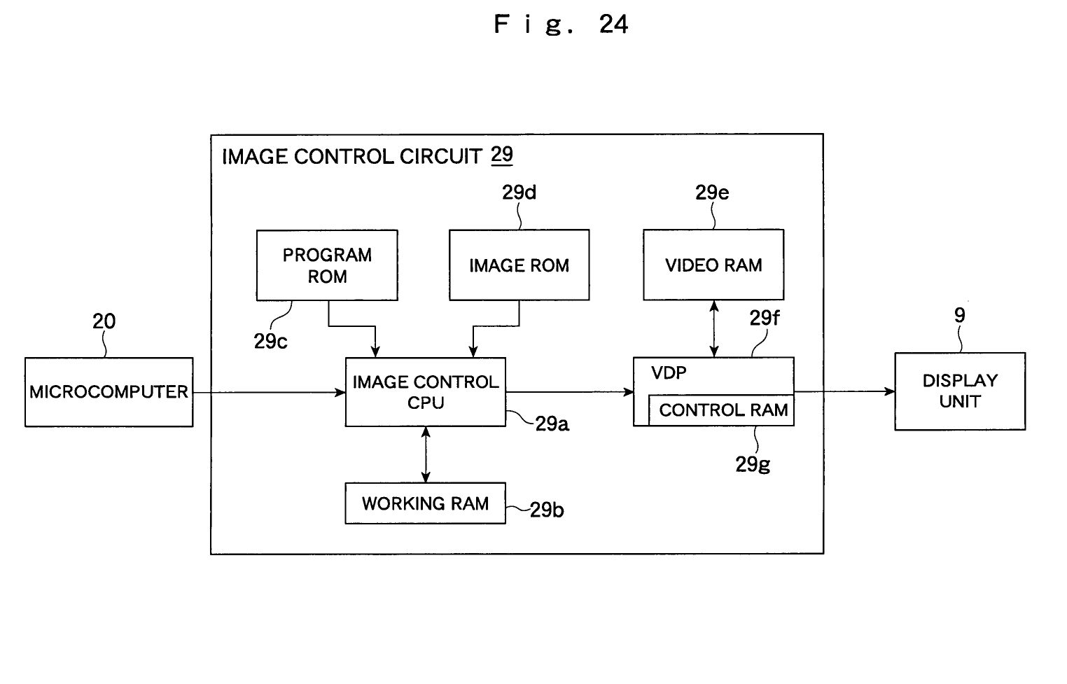

FIG. 23 is a block diagram of the game article supply apparatus 1A, mainly showing its internal structure. FIG. 24 is a block diagram showing one example of the internal structure of the image control circuit 29 shown in FIG. 23. The internal structure of the game article supply apparatus and the internal structure of the image control circuit shown in FIGS. 23 and 24 are similar to the internal structure of the game article supply apparatus 1 and the internal structure of the image control circuit 29 already described in connection with FIGS. 4 and 5 except that the recovery detection sensor 94 and the open-close drive unit 93 are added and that the main CPU 21 receives signals from the various components mounted on the control panel 5 and from the recovery detection sensor 94 via the I/O port 24 and exchanges signals with other components including the open-close drive unit 93. Therefore, those portions corresponding to their counterparts shown in FIGS. 4 and 5 are indicated by the same numerals as in FIGS. 4 and 5 and their description is omitted.

Also, the figure used with the present game article supply apparatus 1A is similar in structure with the FIG. 40 already described in connection with FIG. 7 and so its description is omitted.

(Contents of Operation of Game Article Supply Apparatus)

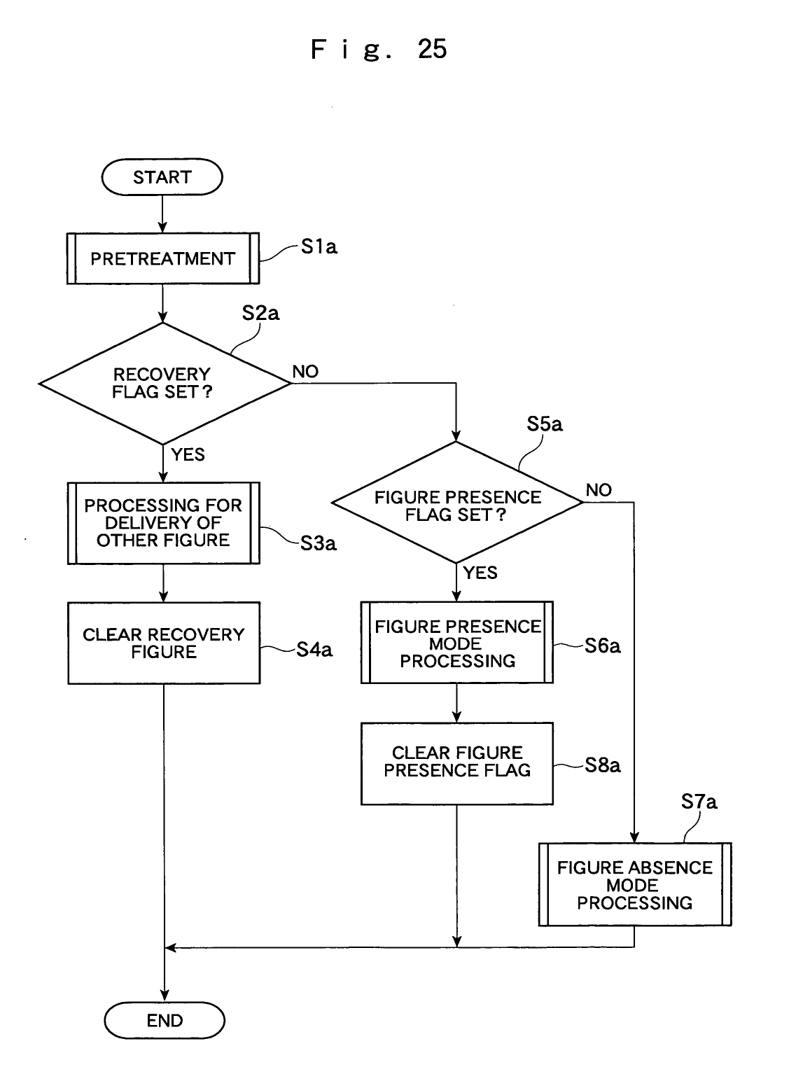

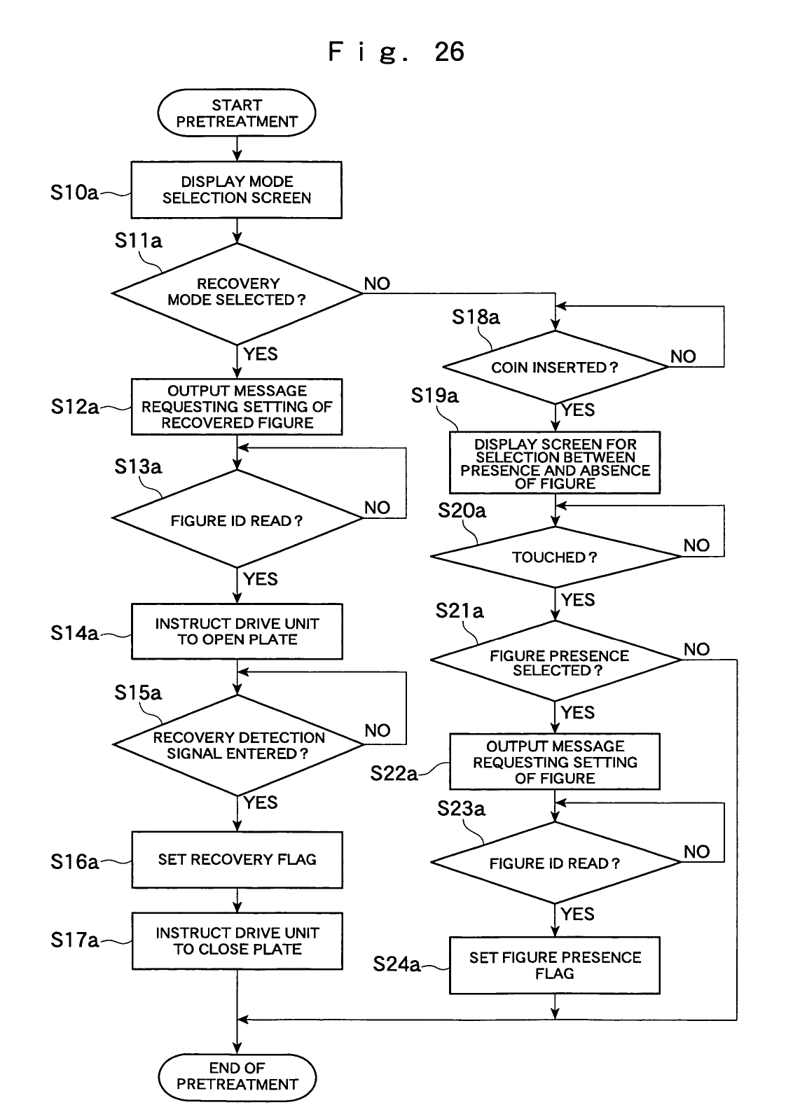

The contents of operation of the game article supply apparatus 1A constructed as described so far are described by referring to the flowcharts shown in FIGS. 25 to 29. FIG. 25 is a flowchart illustrating a procedure for operations from start to end of processing performed in the game article supply apparatus 1A. In FIG. 25 and in FIGS. 26-29 (described later), a process step is abbreviated S.

The game article supply apparatus 1A operates as follows in a case where the FIG. 40 made unnecessary by the player is recovered and in a case where a figure is purchased by inserting coins paying for the FIG. 40 into the coin insertion port 8 to deliver it.

When operation starts, the game article supply apparatus 1A goes to step la, where a pretreatment (described later) is performed, the pretreatment including recovery of the FIG. 40 made unnecessary, a decision made as to whether a coin has been inserted, and a decision made as to whether there is a figure. In step 2a, a decision is made according to the result of the pretreatment as to whether or not given data is set to a recovery flag (described later) (flag is set or not). According to the decision, control branches either to step 3a or step 5a, depending on whether the recovery flag is set or not, respectively. In step 3a, processing for recovery of another figure (described later) is performed. In the next step 4a, the recovery flag is cleared.

Control goes to step 5a, where a decision is made as to whether or not given data is set to a figure presence flag (described later). According to the decision, control branches either to step 6a or to step 7a, depending on whether the figure presence flag is set or not, respectively. Step 8a is executed subsequently to step 6a. If the figure presence flag is cleared or if step 7a is executed, the operation ends.

(Pretreatment)

The game article supply apparatus 1A performs the pretreatment according to the flowchart shown in FIG. 26, which is a flowchart illustrating a procedure for operations of the pretreatment.

When the pretreatment is started, the game article supply apparatus 1A goes to step 10a, where the main CPU 21 instructs the image control circuit 29 to display a mode selection screen. At this mode selection screen, a selection is made between a recovery mode in which the figure is discharged instead of recovering the FIG. 40 (game article to be recovered in the present invention) to be discarded as the figure is made unnecessary and a purchase mode in which a figure is delivered according to insertion of a correct amount of coin.

Then, control goes to step 11a, where a decision is made as to whether or not the recovery mode is selected in step 10a. If the recovery mode is selected, control goes to step 12a. If it is not selected, control proceeds to step 18a. In the step 12a, a message requesting setting of a figure to be recovered (FIG. 40 to be recovered) is output. That is, the image control circuit 29 is operated to display a message requesting the user to set the recovered figure in the authentication unit 7 such that the figure ID is read (e.g., “Please set the pedestal of the figure in the authentication unit”) on the display unit 9. In the next step 13a, the apparatus waits until reading of the figure ID ends. If the player sets the recovered FIG. 40 in the authentication unit 7 according to the displayed message, the authentication unit 7 reads the figure ID stored in the IC chip 44 of the set recovered FIG. 40. If the figure ID has been read, control goes to step 14a, where the main CPU 21 operates as the acceptance control portion and instructs the open-close drive unit 93 to open the open-close plate 92 such that the recovered FIG. 40 can be accepted. In this way, the open-close plate 92 opens, and the player can insert the recovered FIG. 40 into the housing 91 from the opening 91c.

In the following step 15a, the apparatus waits until a recovery detection signal from the recovery detection sensor 94 is entered. If the recovery detection signal is entered (i.e., the recovered FIG. 40 passes into the housing 91 through the opening 91c from the outside and is accepted into the housing 91 by the recovery unit 90), control goes to step 16a, where given data (“9”, in the present embodiment) is set to the recovery flag. In the following step 17a, the main CPU 21 instructs the open-close drive unit 93 to close the open-close plate 92.

On the other hand, if control goes from step 11a to step 18a, it follows that the purchase mode has been selected. Therefore, this is the case where the player purchases the FIG. 40. In step 18a, the apparatus waits until the player inserts a coin. If a correct amount of coin is inserted, control goes to step 19a, where a selection screen is displayed on the display unit 9 to determine whether or not the player possesses a figure (presence or absence of a figure). In the next step 20a, the apparatus waits until the player touches the touch panel 9a. If it is touched, control goes to step 21a, where a decision is made as to whether “presence of a figure” was selected in step 19a. If the “presence of a figure” has been selected, control goes to step 22a; otherwise, the pretreatment is ended.

In the step 22a, a message requesting setting of a figure is output. That is, the image control circuit 29 operates to display a message requesting the same setting as the above-described setting on the display unit 9. In the next step 23a, the apparatus waits until reading of the figure ID ends. If the player sets the FIG. 40 in the authentication unit 7 according to the displayed message, the authentication unit 7 reads the figure ID stored in the IC chip 44 of the FIG. 40. In the next step 24a, given data (“1” in the present embodiment) is set to the figure presence flag indicating that the figure ID of the FIG. 40 has been read by the authentication unit 7 (setting of the figure), and the pretreatment is ended.

(Processing for Delivery of other Figure)

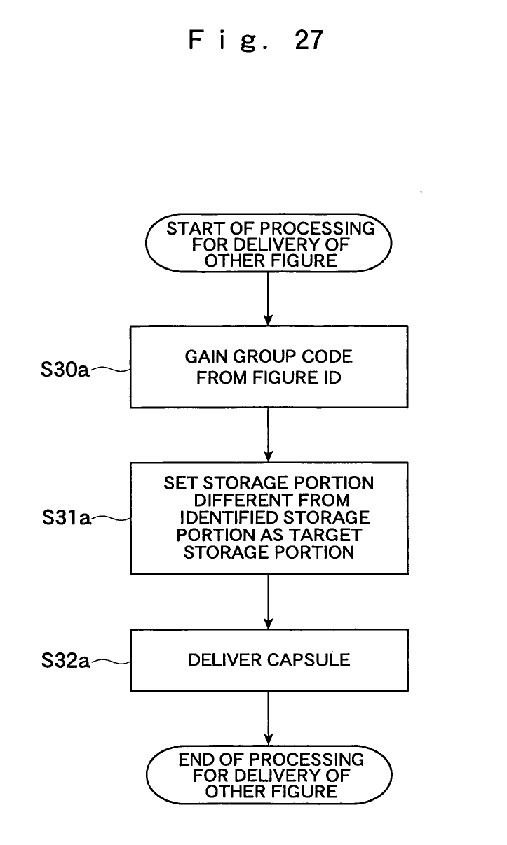

The game article supply apparatus 1A performs processing for delivering other figure according to the flowchart shown in FIG. 27, which is a flowchart illustrating a procedure for operations of the processing for delivery of other figure.

When the processing for delivering other figure is started, the game article supply apparatus 1A goes to step 30a shown in FIG. 27, where the main CPU 21 operates as the identification portion in the present invention, gains a group code contained in the figure ID read in step 13a in FIG. 26, refers to the relationship table, and identifies the accommodation portion 10 corresponding to the group code out of all the accommodation portions 10. In the identified accommodation portion 10, figures of the same character which have the same group code as the group code of the figure whose figure ID has been read but wear different costumes (i.e., characters of different kinds) are accommodated. Then, control goes to step 31a, where processing for setting of the target accommodation portion is performed. In this step, the main CPU 21 operates as the setting portion in the present invention and sets an accommodation portion 10 different from the accommodation portion 10 identified in step 30a as the target accommodation portion in which the figure to be delivered is accommodated. The group code corresponding to the target accommodation portion is herein referred to as the “group code for delivery”. For example, where the group code of the accommodation portion 10 identified in step 30a is A, the group code B is set as the group code for delivery. Where the group code of a similarly identified accommodation portion 10 is B, the group code C is set as the group code for delivery. Similarly, where the group code of the identified accommodation portion 10 is H, the group code A is set as the group code for delivery. In this way, the target accommodation portion is set.

Control then goes to step 32a, where the capsule 47 is delivered from the target accommodation portion 10 set in step 31a. That is, the main CPU 21 operates as the delivery control portion in the present invention and outputs an opening control signal to the drive control circuit 31 to open the shielding plate 15 of the target accommodation portion 10 (in a case where the group code for delivery of the target accommodation portion 10 is B and the shield plate is 152, for example) such that the figure already accommodated in the target accommodation portion 10 set in step 31a is delivered. The drive control circuit 31 drives the motor (e.g., motor M2) corresponding to the opening control signal to open the shield plate 152. Then, the capsule 47 located closest to the shielding plate 152 on the slope 12a rolls out of the delivery port 14, and is delivered into the capsule takeout port 6 through the discharge path 16, as shown in FIG. 21.

In this way, with the game article supply apparatus 1A, if the player selects the recovery mode, the recovered FIG. 40 is accepted on the condition that the figure ID of the recovered FIG. 40 has been read. The FIG. 40 to be recovered can be recovered. If the FIG. 40 to be recovered is recovered, the accommodated figure is delivered and can be supplied to the player. Thus, the game article supply apparatus 1A can sustain the player's will to collect game articles. Furthermore, the apparatus 1A acts not only to recover a figure to be discarded when it is made unnecessary but also to supply the figure on the condition that the recovery is made. Consequently, player's positive recovery of figures can be anticipated. This can promote recovery of figures. In addition, recovery and supply of figures can be interrelated. Hence, it is also possible to promote recycling of figures.

If the figure identical with the recovered figure should be delivered, there is a danger that the delivered figure will be subject to recovery again. However, the game article supply apparatus 1A delivers a figure belonging to a group different from the group of the recovered FIG. 40 and so it is unlikely that the same figure as the recovered figure is delivered. In consequence, the game article supply apparatus 1A is prevented from performing wasteful operation consisting of repeated recovery of a figure. Therefore, players' positive recovery of figures can be anticipated. Recovery of figures can be promoted.

In the present embodiment, a figure belonging to a group different from the group of the recovered FIG. 40 is delivered. The invention is not limited to this method. A figure belonging to the same group as the group of the recovered FIG. 40 may be delivered. In this case, it is unlikely that a figure not associated with the FIG. 40 already possessed by the player is delivered. Consequently, the player's will to collect figures can be sustained further.

(Processing in a Case where there is a Figure)

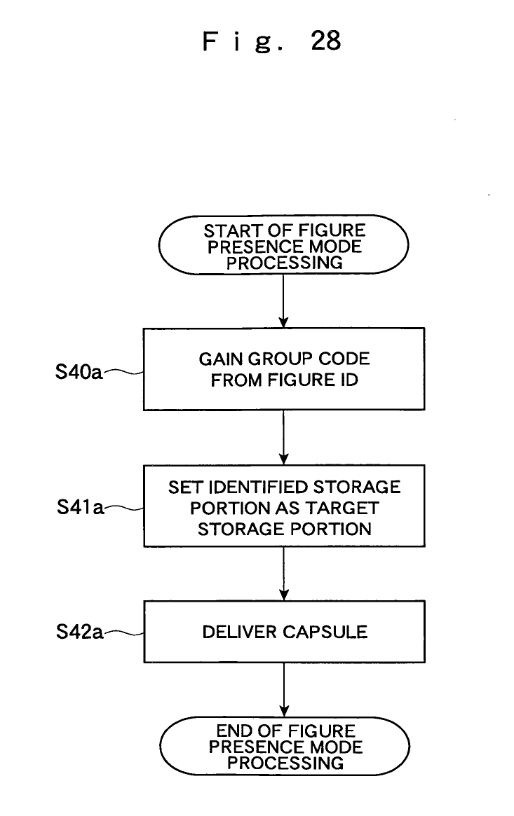

The game article supply apparatus 1A performs processing to be performed in a case where there is a figure (may also be referred to as the “figure presence mode processing”) along the flowchart shown in FIG. 28, which is a flowchart illustrating a procedure for operations of the figure presence mode processing.

When the figure presence mode processing is started, the game article supply apparatus 1A goes to step 40a shown in FIG. 28. The main CPU 21 gains a group code contained in the figure ID read in step 23a of FIG. 26 and identifies the accommodation portion 10 corresponding to the group code. In the next step 41a, the accommodation portion 10 identified in step 40a is set as the target accommodation portion.

Control then goes to step 42a, where the capsule 47 is delivered from the target accommodation portion 10 set in step 41a out of all the accommodation portions 10. That is, the main CPU 21 outputs an opening control signal to the drive control circuit 31 for opening the shielding plate 15 of the target accommodation portion 10 in the same way as in step 32a. The drive control circuit 31 drives the motor corresponding to the opening control signal, opening the shielding plate 15 corresponding to the target accommodation portion 10. The capsule 47 located closest to the shielding plate 15 is made to roll out of the delivery port 14. In this way, the capsule 47 is delivered into the capsule takeout port 6.

As described so far, with the game article supply apparatus 1A, the player can select the purchase mode, in addition to the recovery mode. By selecting the purchase mode, another figure can be purchased in addition to the possessed figure. Furthermore, a figure belonging to the same group as the group of the figure whose figure ID has been read is delivered. Therefore, there is no possibility that a figure not associated with the FIG. 40 already possessed by the player is delivered. This can sustain the player's will to collect figures.

(Processing to be Performed in Cases where there is No Figure)

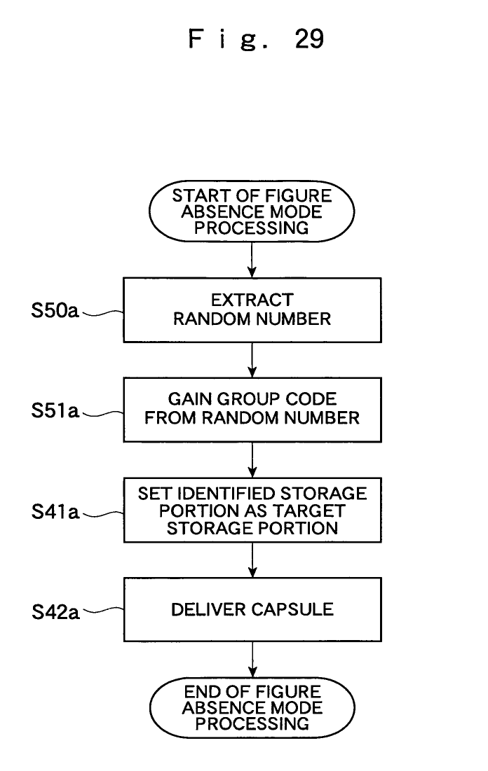

On the other hand, the game article supply apparatus 1A carries out processing to be performed in cases where there is no figure along the flowchart shown in FIG. 29, which is a flowchart illustrating a procedure for operations of the processing (may also be referred to as the “figure absence mode processing”) to be performed in cases where there is no figure. This figure absence mode processing assumes the case where the player possesses no figure (e.g., the player buys a figure for the first time).

When the figure absence mode processing is started, the game article supply apparatus 1A goes to step 50a shown in FIG. 29, where the main CPU 21 instructs the random number generator 25 to produce random numbers (1 to 80 in the present embodiment) and instructs the sampling circuit 26 to extract an arbitrary one out of the random numbers produced by the random number generator 25. In the next step 51a, the random number extracted in step 50a is set to the search key, and the group code table 96 (shown in FIG. 11) stored in the ROM 23 is searched. In the table 96, random numbers and group codes are stored in an interrelated manner. A group code corresponding to the random number is gained. Also, the accommodation portion 10 corresponding to the gained group code is identified. Subsequently, steps 41a and 42a are carried out in the same way as in the figure presence mode processing, to deliver the capsule 47 to the capsule takeout port 6.

In this way, the game article supply apparatus 1A can select the figure absence mode processing as encountered when the player possesses no figure. Even where there is no figure, a figure corresponding to the result of lottery out of random numbers is delivered. Hence, it is possible to buy a figure.

### Fourth Embodiment

### Other Embodiment of the Game Article Supply System

(Whole Configuration of Game Article Supply System)

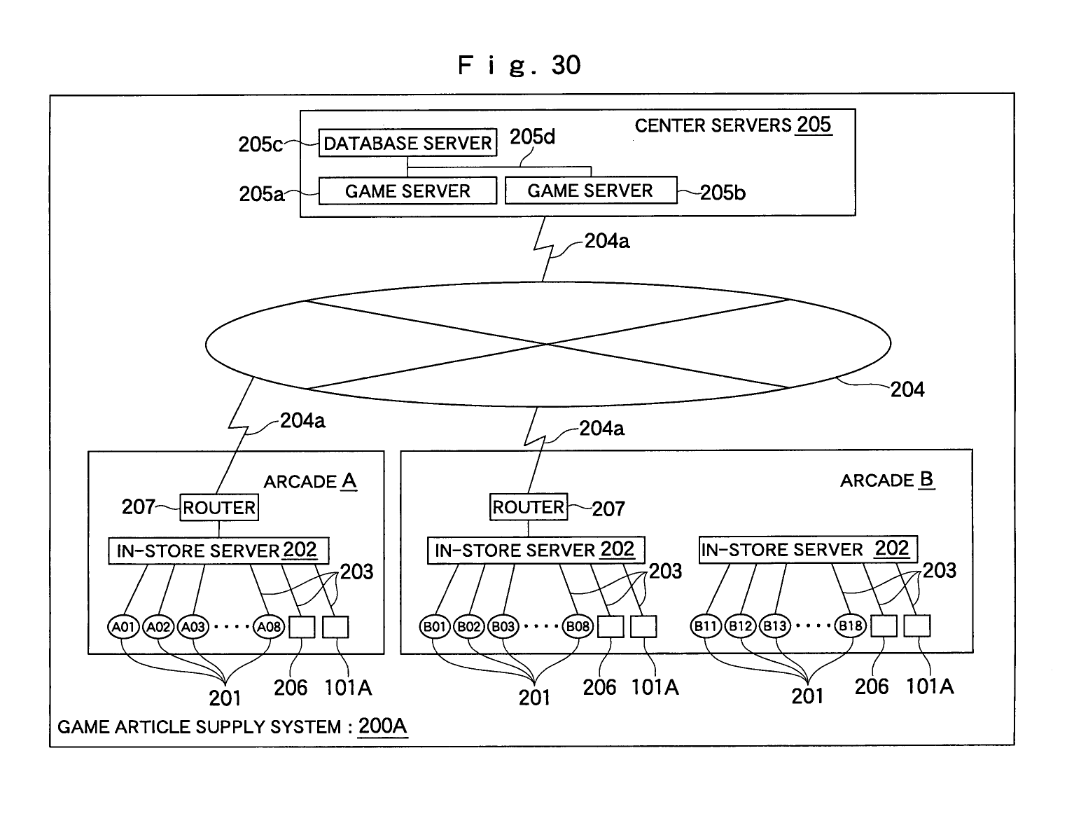

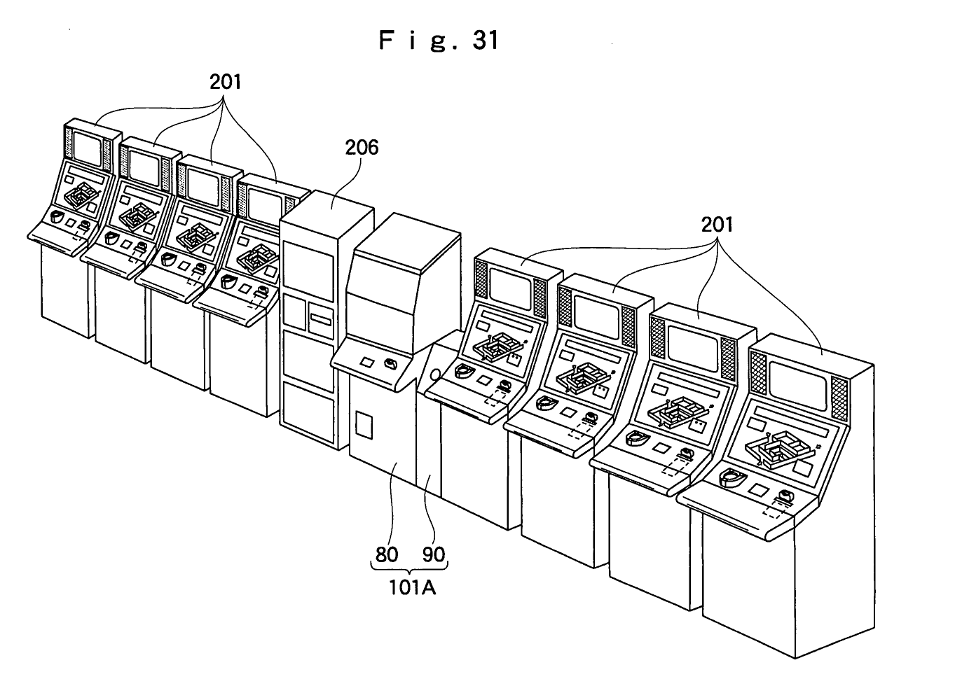

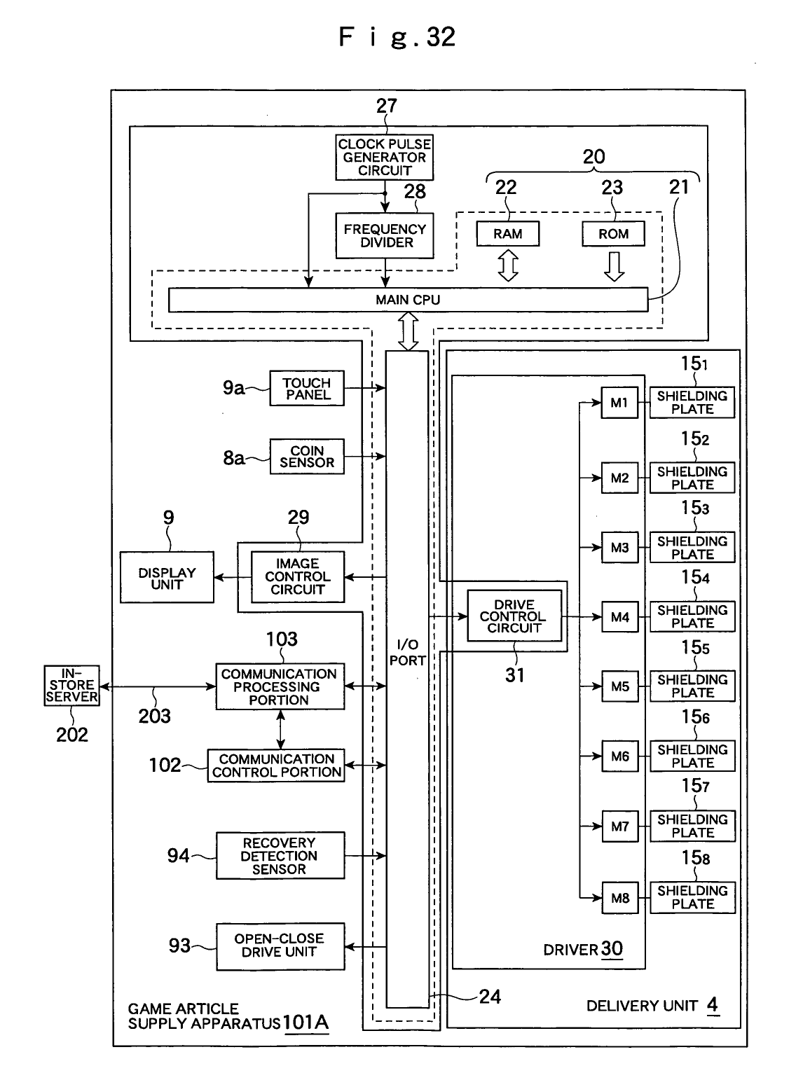

FIG. 30 is a system diagram of a game article supply system 200A equipped with a game article supply apparatus 101A and plural game machines 201. FIG. 31 is a perspective view of the game article supply apparatus 101A, game machines 201, and a card vending machine 206. FIG. 32 is a block diagram of the game article supply apparatus 101A, mainly showing its internal configuration.

The game article supply system 200A has three in-store servers 202 (one in-store server in an arcade A and two in-store servers in another arcade B), game article supply apparatus 101A connected communicably via the dedicated line 203, plural (8 in the present embodiment) game machines 201, the card vending machine 206, in-store routers 207 installed in the arcades A and B, and center servers 205 connected via the in-store routers 207, a communication line 204a, and the Internet 204.

In each of the arcades A and B, the in-store server(s) 202, game article supply apparatus 101A, game machines 201, and card vending machine 206 are connected by the dedicated line 203 to thereby form an in-store LAN (local area network). This in-store LAN is connected with the Internet 204 via the in-store routers 207.

(Configuration of Game Article Supply Apparatus)

The game article supply apparatus 101A is similar in configuration with the aforementioned game article supply apparatus 1A except that the authentication unit 7, random number generator 25, and sampling circuit 26 are omitted but a communication control portion 102 and a communication processing portion 103 are added as shown in FIGS. 31 and 32.

The communication control portion 102 in the game article supply apparatus 101A operates according to instructions from the main CPU 21 and controls connection and disconnection of the network for making communications with the in-store servers 202. The communication processing portion 103 operates according to instructions from the communication control portion 102 and performs sending and reception of data via the dedicated line 203.

(Configuration of Game Machines)

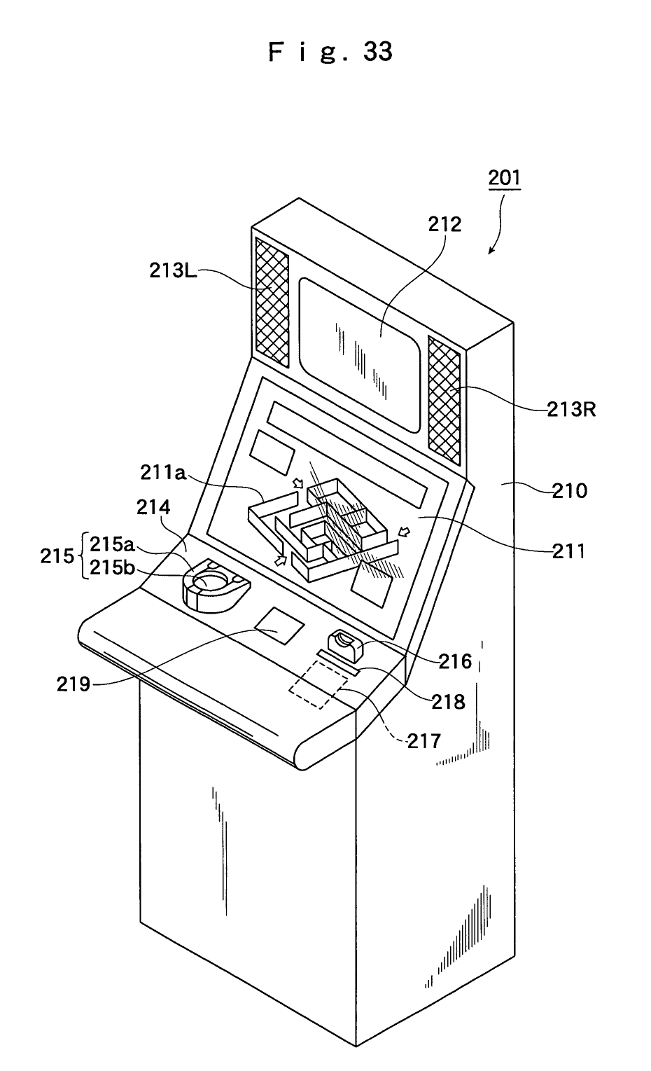

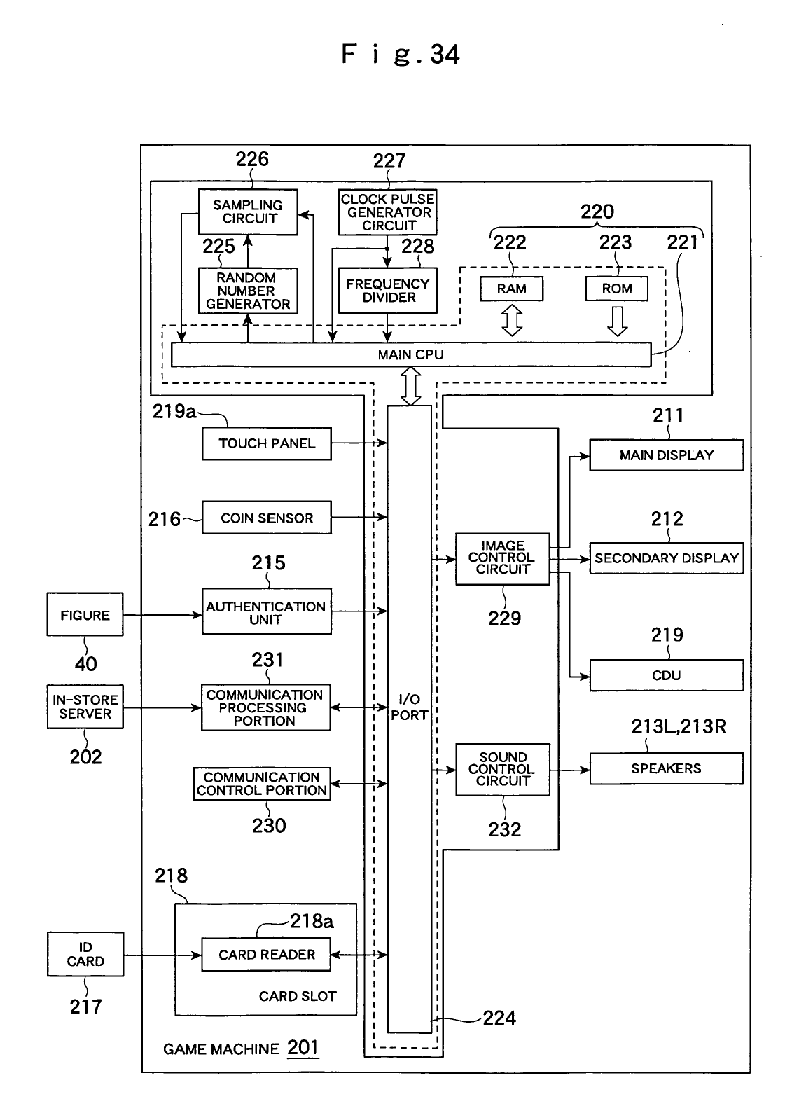

FIG. 33 is a perspective view showing the whole configuration of one game machine 201. FIG. 34 is a block diagram of the game machine 201, mainly showing its internal configuration. The game machine 201 is identical in configuration with the game machine 201 shown in FIGS. 15 and 16 as shown in FIGS. 33 and 34 and so its description is omitted.

(Configuration of In-Store Servers, Card Vending Machine, and In-Store Routers)

Since the in-store servers 202, card vending machine 206, and in-store routers 207 are similar in configuration with their counterparts of the game machine supply system shown in the second embodiment and so their description is omitted.

(Configuration of Center Servers)

The center servers 205 are identical in configuration with their counterparts of the game article supply system shown in the second embodiment.

(Contents of Operations of Game Article Supply Apparatus and Game Machines)

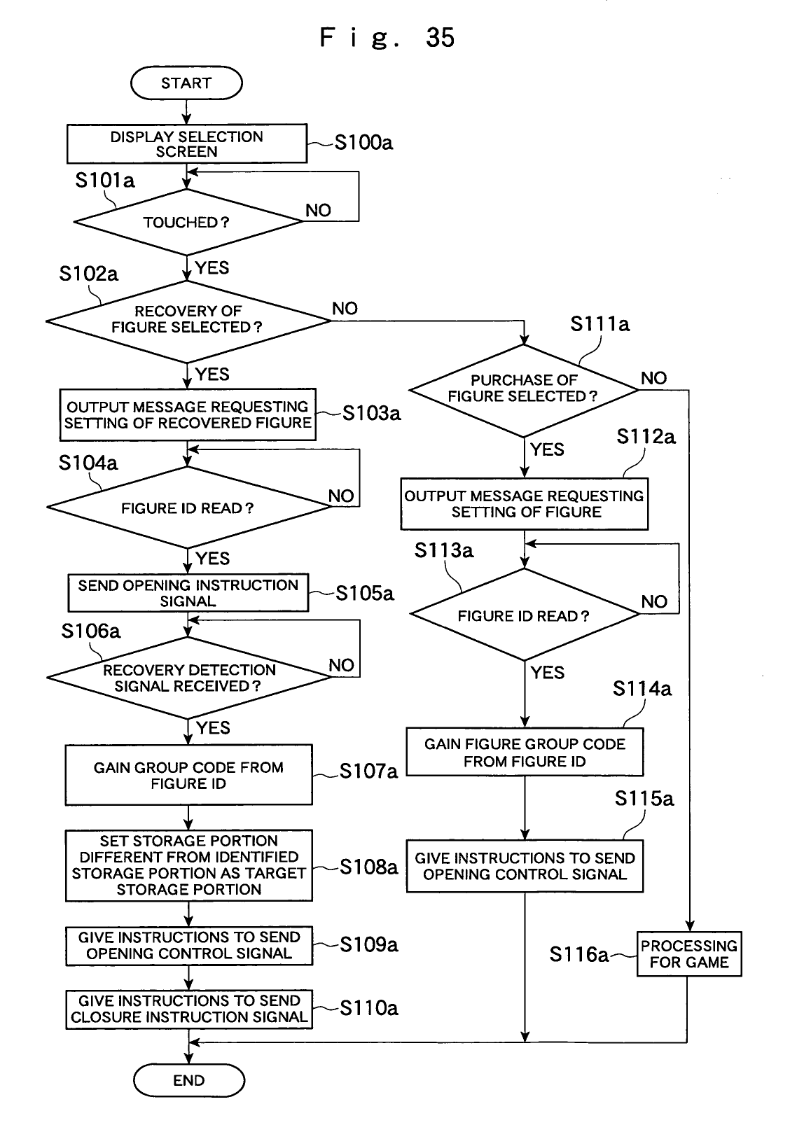

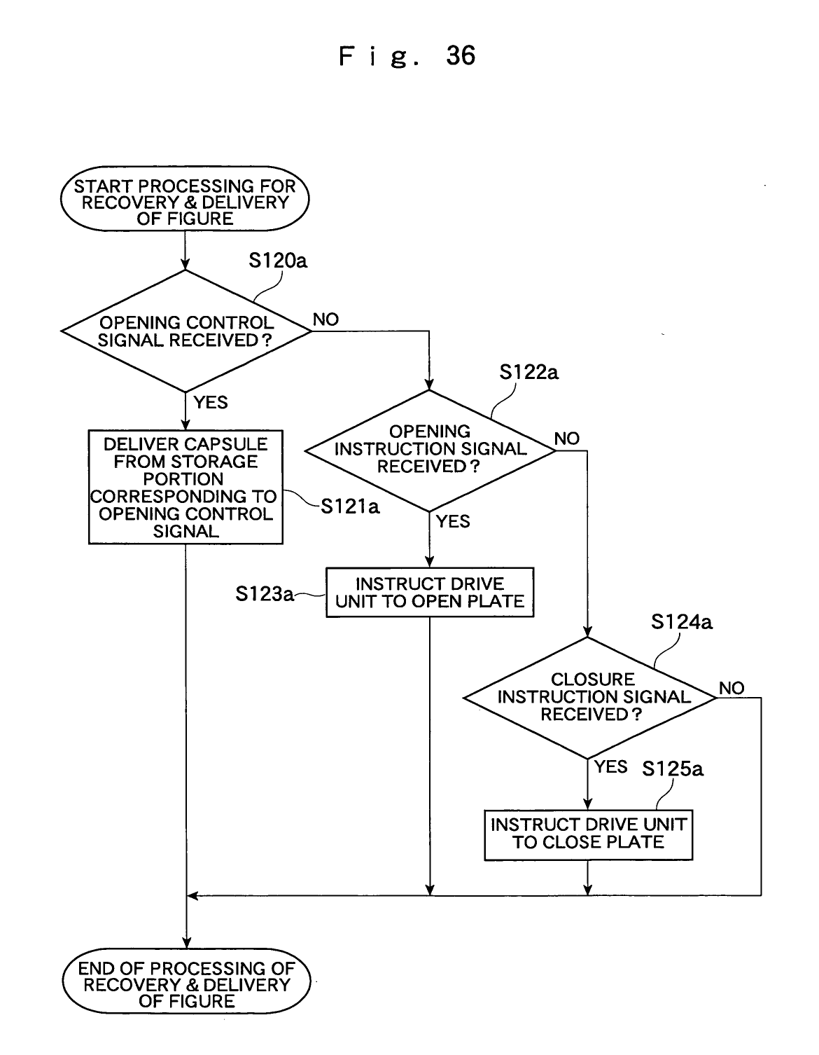

The contents of operations of the game article supply apparatus 101A and game machines 201 constructed as described so far are next described principally in relation to the operation to deliver each capsule 47. FIG. 35 is a flowchart illustrating the control of the delivery from start to end of the processing performed in the game machine 201 and a procedure for operations for processing a game. FIG. 36 is a flowchart illustrating a procedure for operations of processing for recovering and delivering a figure. In FIGS. 35 and 36 (described later), each process step is abbreviated S.

When control of delivery and processing of a game are started, each game machine 201 goes to step 100a, where a mode selection screen is displayed on a control display unit (CDU) 219 to prompt the user to select between purchase of a figure, recovery of a figure, and start of a game. In the subsequent step 101a, the apparatus waits until the player touches a touch panel 219a. If it is touched, control goes to step 102a, where a decision is made as to whether the player has selected the recovery of a figure from the mode selection screen. Where the recovery of a figure is selected, control goes to step 103a. Otherwise, control goes to step 111a.

In step 103a, the control display unit 219 produces a message requesting setting of a recovered FIG. 40 in the same way as in the step 12a. In the next step 104a, the apparatus waits until reading of a figure ID ends. At this time, if the player sets the recovered FIG. 40 in the authentication unit 215 of the game machine 201, the authentication unit 215 reads the figure ID stored in the IC chip 44 of the set recovered FIG. 40, and then control goes to step 105a. In the step 105a, the main CPU 221 operates as the acceptance control portion and activates the communication control portion 230 and communication processing portion 231 to send an opening instruction signal to the game article delivery apparatus 101 for giving an instruction to open the open-close plate 92.

In the next step 106a, the apparatus waits until a recovery detection signal from the game article delivery apparatus 101 is received. If the detection signal is received from the delivery apparatus 101, control goes to step 107a, where the main CPU 221 operates as the identification portion in the present invention, gains a group code contained in the figure ID read in step 104a, and identifies the accommodation portion 10 corresponding to the group code. In the next step 108, the main CPU 221 operates as the setting portion in the present invention and sets an accommodation portion different from the accommodation portion 10 identified in the step 107a as a target accommodation portion. In the next step 109a, the main CPU 221 operates as the delivery control portion in the present invention and activates the communication control portion 230 and communication processing portion 231 to send an opening control signal to the game article delivery apparatus 101 for opening the shielding plate 15. This permits the figure already accommodated in the target accommodation portion 10 to be delivered. In the following step 110a, the main CPU 221 operates the communication control portion 230 and communication processing portion 231 to send a closure instruction signal for closing the open-close plate 92 of the game article supply apparatus 101A. Control of delivery and processing of the game are ended.

On the other hand, if control goes from step 102a to step 111a, a decision is made as to whether the player selected the purchase of a figure in step 100a. If the purchase has been selected, control goes to step 112a. If start of a game has been selected, control goes to step 116a, where processing of the game is performed. Processing necessary for execution of a labyrinth combat game is performed. Thus, the control of delivery and processing of the game are ended.

If control goes to step 112a, a message requesting setting of a figure is output. That is, the image control circuit 229 operates according to instructions from the main CPU 221 and produces the message requesting setting of the FIG. 40 in the same way as in the step 22a. In the next step 113a, the apparatus waits until reading of the figure ID ends. If the player sets the possessed FIG. 40 in the authentication unit 215 of the game machine 201, the authentication unit 215 reads the figure ID stored in the IC chip 44 of the set FIG. 40. Control then goes to step 114a. In the step 114a, a group code is gained from the figure ID read in step 113a, the corresponding accommodation portion 10 is identified, and the identified accommodation portion 10 is set as the target accommodation portion. If control then goes to step 115a, the main CPU 221 operates the communication control portion 230 and communication processing portion 231 to send an opening control signal to the game article delivery apparatus 101, for driving the shielding plate 15 of the target accommodation portion 10. If the opening control signal is sent, the control of delivery and processing of the game are ended.

By performing the control of delivery and processing of a game for the game machine 201 in this way, control of delivery for delivering other figure is performed in the game machine 201 in exchange for control of acceptance for recovery of the recovered FIG. 40 and recovery of the recovered FIG. 40 such that the FIG. 40 to be recovered is recovered by the game article supply apparatus 101A. The accommodation portion 10 in which the figure to be delivered is accommodated is identified from the read figure ID and a target accommodation portion is set in relation to the control of delivery.

Meanwhile, the game article supply apparatus 101A performs processing for recovery and delivery of a figure along the flowchart shown in FIG. 36. When the processing for recovery and delivery of a figure is started, the game article supply apparatus 101A goes to step 120a, where a decision is made as to whether or not the opening control signal sent from the game machine 201 has been received. If the opening control signal has been received, control goes to step 121a. Otherwise, control goes to step 122a. In the step 121a, the main CPU 21 instructs the drive control circuit 31 to operate the corresponding motor according to the opening control signal received by the communication processing portion 103, thus opening the shielding plate 15. The capsule 47 located closest to the opened shielding plate 15 rolls out of the delivery port 14 and is delivered into the capsule takeout port 6. After execution of the step 121a, the processing for recovery and delivery of a figure is ended.

Furthermore, if control goes to step 122a, a decision is made as to whether or not the opening instruction signal sent from the game machine 201 has been received. If the opening instruction signal has been received, control goes to step 123a. Otherwise, control proceeds to step 124a. In the step 123a, the main CPU 21 instructs the open-close drive unit 93 to open the open-close plate 92 according to the received opening instruction signal. This permits the player to enter the recovered FIG. 40 into the housing 91 from the opening 91c. The FIG. 40 to be recovered can be recovered by the game article supply apparatus 101A. After execution of the step 123a, the processing for recovery and delivery of a figure is ended.

If control then goes to step 124a, a decision is made as to whether a closure instruction signal sent from the game machine 201 has been received. If the closure instruction signal has been received, control goes to step 125a. Otherwise, the processing for recovery and delivery of a figure is ended. In the step 125a, the main CPU 221 instructs the open-close drive unit 93 to close the open-close plate 92 according to the received closure instruction signal. After execution of the step 123a, the processing for recovery and delivery of a figure is ended.

In the game article supply system 200A having the game article supply apparatus 101A and plural game machines 201, the player can select recovery mode and purchase mode, in addition to start of a game, on one game machine 201 as described above. If the player selects the recovery mode, the game article supply apparatus 101A accepts the recovered FIG. 40 under acceptance control of the game machine 201 on the condition that the figure ID of the recovered FIG. 40 has been read. Thus, the FIG. 40 to be recovered can be recovered. If this recovery of the FIG. 40 is done, the figure is delivered by the game article supply apparatus 101A under delivery control of the game machine 201. The figure is supplied to the player. Hence, the game article supply system 200A can sustain the player's will to collect game articles. Furthermore, the supply system 200A acts not only to recover a figure to be discarded but also to supply a figure on the condition that the recovery is made. Consequently, player's positive recovery of figures can be anticipated. This can promote recovery of figures. In addition, recovery and supply of figures can be interrelated. Hence, it is also possible to promote recycling of figures.

Others

In the embodiments described so far, when a figure is delivered in exchange for recovery, a figure belonging to a figure group different from the group of the figure read with the authentication unit is delivered. Alternatively, figures of characters simulating the shapes of monsters or the like or figures having figure information in which the values of the performance indicative of the characters or special abilities (hereinafter referred to as rare figures) have been enhanced may be contained in capsules, and these capsules may be accommodated in some accommodation portions 10. The rare figures may be delivered.

In particular, 8 kinds of figures including normal figures having group codes A1-D1 and rare figures having group codes A2-D2 are accommodated in the accommodation portions 10 of the game article supply apparatus 1 and 101. The normal figures are figures of characters simulating persons or figures whose values of abilities or special abilities are set lower than those of the rare figures. The normal figures of group codes A1-D1 correspond to the rare figures of group codes A2-D2, respectively. For instance, the rare figure of group code A2 is located at a higher category than the normal figure of group code A1. In this modified embodiment, too, the group codes A1-D1 and A2-D2 are contained in some of the figure IDs stored in the IC chips 44 possessed by the figures.

Where the player possesses any normal figure and wants to discard it, if the normal figure is set in the authentication unit 7 or 215 prior to the disposal, the figure ID is read, the group code (any one of A1-D1) is gained, and the accommodation portion 10 is identified. If the relationship table (not shown) in which normal figures and rare figures are stored in relation to their group codes is referenced, the group code (any one of A2-D2) of the corresponding rare figure is gained. In this way, the accommodation portion in which the rare figure corresponding to the discarded normal figure is accommodated is set as a target accommodation portion. The rare figure is delivered in exchange for recovery of the normal figure.

Furthermore, it is also possible to determine by lottery out of random numbers as to whether the relationship table is referenced or not when the figure ID of a normal figure is read and a group code (any one of A1-D1) is gained. For example, random numbers 1-100 may be produced and the following method may be implemented. Where the extracted random number is 1 to 80, for example, the accommodation portion corresponding to the group code (any one of A1-D1) of the normal figure gained without referring to the relationship table is set as a target accommodation portion. Where the extracted random number is 81-100, the accommodation portion corresponding to the group code (any one of A2-D2) of the rare figure is set as a target accommodation portion by referring to the relationship table. As a result, normal figures can be delivered at a probability of 80% and rare figures can be delivered at a probability of 20%.

While other embodiments of the game article supply apparatus and game article supply system of the present invention have been described in detail so far, the invention is not limited thereto but rather various changes and modifications are possible. That is, in the above-described game article supply apparatus 1, the FIG. 40 is taken as an example of a game article. The present invention can also be applied to a case where a game article different from the FIG. 40 is recovered. For example, game cards, card-like tokens, or cassettes which bear pictures or patterns corresponding to characters and which store ID information and other information may be recovered.

In the game article supply apparatus 1, the accommodation unit 3 has plural accommodation portions 10. The accommodation unit may have a single accommodation portion 10.

When the FIG. 40 is being read, the authentication unit 7 or 215 may inform the player that the figure ID is being read by illuminating the FIG. 40 with light with LEDs.

In addition, a capsule containing a part that the figure can wear or carry such as a weapon or protector may be delivered in exchange for recovery of a figure. Furthermore, this part may be worn on the figure to improve figure information such as a value indicative of the character capability or special capability.

Although each game machine 101 is equipped with the main display 211 for displaying images for a game and with the secondary display 212, the main display 211 and the secondary display 212 may be mounted as separate units.

In the description of the above embodiments, an example in which the main CPU 221 of each game machine 101 acts as the acceptance control portion and also as the delivery control portion is taken. Alternatively, the program executed by each in-store server 202 may be so configured that the CPU of the in-store server 202 operates as the acceptance control portion and as the delivery control portion. In this way, a game article supply system may be built. Moreover, a game article supply system may be built by installing an apparatus which is identical in functions with the aforementioned various portion, apart from the game machines 101 and in-store servers 202.

What is claimed is:

1. An apparatus for supplying game articles, the apparatus comprising:
an accommodation unit having at least one accommodation portion for accommodating plural articles used for a game, the accommodation unit being designed such that plural kinds of game articles are accommodated in the accommodation unit;
a delivery unit for delivering the game articles accommodated in the accommodation unit; and
a game article supply portion which supplies a game article delivered from the accommodation unit by the delivery unit, based on information about a game article.

2. An apparatus for supplying game articles as set forth in claim 1, wherein the accommodation unit has plural accommodation portions, and wherein the game article supply portion has (a) a reading portion for reading identification information which is stored in storage portions of the game articles, permits the game articles to be discriminated, and permits the accommodation portions to be identified, (b) an identification portion for identifying the accommodation portion corresponding to the identification information read by the reading portion, and (c) a delivery control portion for operating the delivery unit to deliver the game articles accommodated in the accommodation portion identified by the identification portion.

3. An apparatus for supplying game articles as set forth in claim 1,
wherein the accommodation unit has plural accommodation portions;
wherein the game article supply portion has (a) a reading portion for reading identification information which is stored in storage portions of the game articles, permits the game articles to be discriminated, and permits the accommodation portions to be identified, (b) an identification portion for identifying the accommodation portion corresponding to the identification information read by the reading portion, (c) a delivery control portion for operating the delivery unit to deliver the game articles accommodated in the accommodation portion identified by the identification portion, and (d) a setting portion for setting instruction information indicating whether or not the identification information has been read by the reading portion; and
wherein the identification portion identifies the accommodation portion by lottery out of random numbers if the instruction information set by the setting portion indicates that the identification information has not been read.

4. A system for supplying game articles as set forth in claim 1, wherein the game article supply portion has
(a) an acceptance portion for performing an operation for accepting game articles from the outside,
(b) a reading portion for reading identification information which is stored in storage portions of the game articles, permits the game articles to be discriminated, and permits the accommodation portions to be identified,
(c) an acceptance control portion for operating the acceptance portion such that game articles to be recovered from which the identification information has been read can be accepted when the identification information is read by the reading portion, and
(d) a delivery control portion for operating the delivery unit such that the game articles accommodated in the accommodation units are delivered when the game articles to be recovered are accepted by the acceptance portion.

5. An apparatus for supplying game articles as set forth in claim 1,
wherein the accommodation unit has plural accommodation portions;
wherein the game article supply portion has (a) an acceptance portion for performing an operation for accepting game articles from the outside, (b) a reading portion for reading identification information which is stored in storage portions of the game articles, permits the game articles to be discriminated, and permits the accommodation portions to be identified, (c) an acceptance control portion for operating the acceptance portion such that game articles to be recovered from which the identification information has been read can be accepted when the identification information is read by the reading portion, (d) a delivery control portion for operating the delivery unit such that the game articles accommodated in the accommodation units are delivered when the game articles to be recovered are accepted by the acceptance portion, (e) an identification portion for identifying the accommodation portion corresponding to the identification information read by the reading portion, and (f) a setting portion for setting an accommodation portion different from the accommodation portion identified by the identification portion as a target accommodation portion into which the accommodated game articles are delivered; and
wherein the delivery control portion operates the delivery unit such that the accommodated game articles accommodated in the target accommodation portion set by the setting portion are delivered.

6. A system for supplying game articles, the system comprising:
a game article supply apparatus having an accommodation unit and a delivery unit, the accommodation unit having an accommodation portion for accommodating plural game articles used for games, the delivery unit acting to deliver the game articles accommodated in the accommodation unit; and
a game machine permitting image games to be played using images of games corresponding to the articles for the games;
wherein the accommodation portion accommodates plural kinds of game articles; and
wherein the game article supply portion which supplies a game article delivered from the accommodation unit by the delivery unit, based on information about a game article

7. A system for supplying game articles as set forth in claim 6, wherein the accommodation unit has plural accommodation portions, and wherein the game article supply portion has (a) a reading portion for reading identification information which is stored in storage portions of the game articles, permits the game articles to be discriminated, and permits the accommodation portions to be identified, (b) an identification portion for identifying the accommodation portion corresponding to the identification information read by the reading portion, and (c) a delivery control portion for operating the delivery unit to deliver the game articles accommodated in the accommodation portion identified by the identification portion.

8. A system for supplying game articles as set forth in claim 6, wherein the game article supply portion has (a) an acceptance portion for performing an operation for accepting game articles from the outside, (b) a reading portion for reading identification information which is stored in storage portions of the game articles, permits the game articles to be discriminated, and permits the accommodation portions to be identified, (c) an acceptance control portion for operating the acceptance portion such that a game article to be recovered from which identification information has been read can be accepted when the identification information is read by the reading portion, and (d) a delivery control portion for operating the delivery unit such that the game article accommodated in the accommodation unit is delivered when the game article to be recovered is accepted by the acceptance portion.

9. A system for supplying game articles as set forth in claim 6,
wherein the accommodation unit has plural accommodation portions;
wherein the game article supply portion has
(a) an acceptance portion for performing an operation for accepting game articles from the outside,
(b) a reading portion for reading identification information which is stored in storage portions of the game articles, permits the game articles to be discriminated, and permits the accommodation portions to be identified,
(c) an acceptance control portion for operating the acceptance portion such that game articles to be recovered from which the identification information has been read can be accepted when the identification information is read by the reading portion,
(d) a delivery control portion for operating the delivery unit such that the game articles accommodated in the accommodation units are delivered when the game articles to be recovered are accepted by the acceptance portion,
(e) an identification portion for identifying the accommodation portion corresponding to the identification information read by the reading portion, and
(f) a setting portion for setting an accommodation portion different from the accommodation portion identified by the identification portion as a target accommodation portion into which the accommodated game article is delivered; and
wherein the delivery control portion operates the delivery unit such that the game article already accommodated in the target accommodation portion set by the setting portion is delivered.
